(19) United States
(12) Patent Application Publication
(10) Pub. No.: US 2025/0026579 A1
(43) Pub. Date: Jan. 23, 2025

(54) CONVEYOR CONTROLLING APPARATUS AND METHOD

(71) Applicants: DAIFUKU OCEANIA LIMITED, Hallam, Victoria (AU); DAIFUKU CO., LTD., Osaka-shi, Osaka (JP)

(72) Inventors: Jian ZHANG, Browns Bay, Auckland (NZ); Priyantha GUNASEKARA, Albany, North Shore City (NZ); Olivier BUNEL, Hadfield, Victoria (AU); Richard PAUL, Massey, Auckland (NZ)

(73) Assignees: DAIFUKU OCEANIA LIMITED, Hallam, Victoria (AU); DAIFUKU CO., LTD., Osaka-shi, Osaka (JP)

(21) Appl. No.: 18/713,149

(22) PCT Filed: Nov. 23, 2022
(86) PCT No.: PCT/AU2022/051399

§ 371 Date: May 23, 2024

(30) Foreign Application Priority Data
Nov. 29, 2021 (WO) PCT/AU2021/051420

(51) Int. Cl. B65G 43/02; G06T 7/00; G06T 7/70; G06V 20/52; G06V 40/10

(52) U.S. Cl. CPC B65G 43/02; G06T 7/0002; G06T 7/70; G06V 20/52; G06V 40/10; B65G 2203/041; B65G 2207/40; G06T 2207/20081; G06T 2207/30196; G06T 2207/30232

(57) ABSTRACT

A conveyor controlling apparatus for controlling a conveyor in accordance with environment parameters with respect to the conveyor includes: a capturing device for capturing an environmental image related to the conveyor; an image-analysing module for determining, based on the environmental image captured by the capturing device, whether an operational condition of the conveyor is satisfied; and a conveyor-controlling module for controlling the conveyor based on a result of the determination carried out by the image-analysing module, wherein if the image-analysing module determines that the operational condition is not satisfied, then the conveyor-controlling module stops the conveyor.

### FIELD OF THE INVENTION

The present invention relates to a conveyor controlling apparatus and a conveyor controlling method for controlling a conveyor in accordance with environment parameters with respect to the conveyor.

### BACKGROUND OF THE INVENTION

In recent years, automatic systematisation in logistics has been steadily progressing, and technologies related to automating warehouse management and handling of conveyance items such as checked-luggage and parcels at airports have been developed. The technologies related to automated systems in logistics include, for example, U.S. Pat. No. 5,165,520 Publication, US Patent Application Publication No. 2018/0148271 and U.S. Pat. No. 7,055,672 Publication.

Nevertheless, it is still common to input conveyance items to automatic conveyance systems by hand. For example, in conventional airports, it is common that the checking-in of passengers' luggage is manually handled by ground handling staff. However, even if the ground-handling staff are well trained, there will invariably by situations where the luggage is presented in an inappropriate configuration, or portions of the luggage are in an awkward position (for example, the handle of a suitcase may be extended, or the zipper on a duffel bag may open). This problem is also prevalent in self-drop luggage kiosks.

The checked-luggage can be in transit on a baggage handling system (BHS) and on its way to being loaded onto a departing plane. Therefore, to ensure that the loading of the checked-luggage is seamless and does not cause any delay to the departing plane, it is vital to ensure that further checks and measures are in place to ensure that all checked-luggage satisfy a ‘forwarding condition’ before being loaded onto the plane.

The forwarding condition is mainly subject to capability of the BHS. Accordingly, if a conveyance item does not meet the forwarding condition, it may cause problems in the BHS such as conveyance jams.

Thus, a solution is required that automatically detects any checked-luggage that does not satisfy the forwarding condition. This solution must be capable of clearly identifying the problematic luggage (among all the other luggage) so that appropriate counter measures can be quickly taken (i.e. an operator can manually fix or adjust the position or configuration of the luggage). The solution should also be robust enough to accept feedback and learn and adapt to updating standards for identification of defective luggage.

Another problem is that an operator or a passenger, either accidentally or intentionally, enters an area, in which humans must not be allowed to enter (i.e. a keep-out zone), near an automatic conveyance system. This kind of incident may lead to a disruption of operation of the automatic conveyance system.

An object of the present invention is to provide a conveyor controlling apparatus and a conveyor controlling method have been created in light of such problems to improve the reliability of conveyance systems having conveyors.

### SUMMARY OF THE INVENTION

A conveyor controlling apparatus for controlling a conveyance object on a conveyor in accordance with a conveyance state of the conveyance object, the apparatus comprises:
an upstream capturing device configured to capture an upstream image of the conveyance object when the conveyance object is in a first upstream-assessment zone on the conveyor and while the conveyance object is conveyed by the conveyor in a direction towards the upstream capturing device;
a downstream capturing device configured to capture a downstream image of the conveyance object in a second downstream-assessment zone on the conveyor, the second downstream-assessment zone being set further downstream when compared to the first upstream-assessment zone;
an image-analysing module configured to determine, based on the upstream image and/or the downstream image, whether the conveyance state of the conveyance object satisfies a forwarding condition; and
a conveyor-controlling module configured to control the conveyor based on a result of the determination carried out by the image-analysing module;
wherein if the image-analysing module determines, based on the upstream image, that the conveyance state of the conveyance object does not satisfy the forwarding condition, then the conveyor-controlling module stops the conveyor such that the conveyance object is positioned in the second downstream-assessment zone, and
wherein if the image-analysing module determines, based on the downstream image, that the conveyance state of the conveyance object satisfies the forwarding condition, then the conveyor-controlling module restarts the conveyor.

The conveyor controlling apparatus, wherein
the image-analysing module is further configured to implement a learning model,
the learning model adapted to define an assessment standard for the conveyance state, and
the image-analysing module utilises the learning model in the determination of whether the conveyance state of the conveyance object satisfies a forwarding condition.

The conveyor controlling apparatus, further comprises:
an overriding module configured to execute an overriding operation, which is an operation forcibly restarts the conveyor, even when the image-analysing module determines based on the downstream image that the conveyance state of the conveyance object does not satisfy the forwarding condition, in response to an overriding command; and
a training module configured to update the learning model based on the overriding command and the upstream-side and/or downstream images of the conveyance object whenever the overriding operation is executed by the overriding module, wherein
the overriding command includes a reason of execution of the overriding operation.

The conveyor controlling apparatus, wherein
the upstream capturing device and the downstream capturing device are adjacent to one another and orientated in opposing directions.

The conveyor controlling apparatus further comprises:
a main body;
a pillar extending upwardly from the main body; and
a head unit provided at a top end of the pillar, wherein
the upstream capturing device and the downstream capturing device are mounted in the head unit.

The conveyor controlling apparatus further comprises:
an upstream lighting device configured to illuminate the first upstream-assessment zone in which the upstream image is captured by the upstream capturing device; and
a downstream lighting device configured to illuminate the second downstream-assessment zone in which the downstream image is captured by the downstream capturing device.

The conveyor controlling apparatus, wherein
the upstream lighting device and the downstream lighting devices are mounted in the head unit.

The conveyor controlling apparatus, wherein
a zone-separation distance, which is a distance between the first upstream-assessment zone and the second downstream-assessment zone, and
the zone-separation distance is adjusted according to a processing capability of the image-analysing module.

The conveyor controlling apparatus further comprises:
an alarm device configured to provide a visual and/or aural notification of the result of the determination carried out by the image-analysing module.

A conveyor controlling method for controlling a conveyance object on a conveyor in accordance with a conveyance state of the conveyance object, the method comprises steps of:
capturing an upstream image of the conveyance object by an upstream capturing device when the conveyance object is in an first upstream-assessment zone on the conveyor and while the conveyance object is being conveyed by the conveyor in a direction towards the upstream capturing device;
capturing a downstream image of the conveyance object by a downstream capturing device in a second downstream-assessment zone on the conveyor, the second downstream-assessment zone being set further downstream when compared to the first upstream-assessment zone;
determining, based on the upstream image and/or the downstream image, whether the conveyance state of the conveyance object satisfies a forwarding condition; and
controlling the conveyor based on a result of the determination step,
wherein if the determination step determines, based on the upstream image, that the conveyance state does not satisfy the forwarding condition, then the controlling step stops the conveyor such that the conveyance object is positioned in the second downstream-assessment zone, and
wherein if the determination step determines, based on the downstream image, that the conveyance state satisfies the forwarding condition, then the controlling step restarts the conveyor.

The controlling method, further comprises steps of:
providing a learning model defining an assessment standard to the conveyance state; and
recognising the conveyance state of the conveyance object based on the learning model and the upstream image and/or the downstream image, wherein
the determining step determines whether the conveyance state, which is recognised in the recognising step, satisfies the forwarding condition.

The controlling method further comprises steps of:
executing an overriding operation, which is an operation forcibly restarts the conveyor, even when the determining step determines, based on the downstream image, that the conveyance state of the conveyance object does not satisfy the forwarding condition, in response to an overriding command; and
updating the learning model based on the overriding command and the upstream image and/or the downstream image of the conveyance object whenever the overriding operation is executed, wherein
the overriding command includes a reason of execution of the overriding operation.

The controlling method, wherein
the upstream capturing device and the downstream capturing device are adjacent to one another and orientated in opposing directions.

The controlling method further comprises steps of:
providing a main body;
providing a pillar extending upwardly from the main body;
providing a head unit at a top end of the pillar; and
providing the upstream capturing device and the downstream capturing device in the head unit.

The controlling method further comprises steps of:
providing an upstream lighting device configured to illuminate the first upstream-assessment zone in which the upstream image is captured by the upstream capturing device; and
providing a downstream lighting device configured to illuminate the second downstream-assessment zone at which the downstream image is captured by the downstream capturing device.

The controlling method, wherein
the upstream and downstream lighting devices are mounted in the head unit.

The controlling method further comprises a step of:
adjusting a zone-separation distance, which is a distance between the first upstream-assessment zone and the second downstream-assessment zone, according to a processing capability of the determining step.

The controlling method further comprises a step of:
visually and/or aurally notifying the result of the determining step.

A conveyor controlling apparatus for controlling a conveyor in accordance with environment parameters with respect to the conveyor, the apparatus comprises:
a capturing device for capturing an environmental image related to the conveyor;
an image-analysing module for determining, based on the environmental image captured by the capturing device, whether an operational condition of the conveyor is satisfied; and
a conveyor-controlling module for controlling the conveyor based on a result of the determination carried out by the image-analysing module,
wherein if the image-analysing module determines that the operational condition is not satisfied, then the conveyor-controlling module stops the conveyor.

The conveyor controlling apparatus, wherein
the capturing device captures an object image of a conveyance object on the conveyor when the conveyance object is in an assessment zone on the conveyor,
the object image is the environmental image with respect to the conveyance object,
the image-analysing module determines based on the object image captured by the capturing device whether a conveyance state of the conveyance object satisfies a forwarding condition,
the forwarding condition is the operational condition with respect to the conveyance object, and
if the image-analysing module determines based on the object image that the conveyance state of the conveyance object does not satisfy the forwarding condition, then the conveyor-controlling module stops the conveyor such that the conveyance object is positioned within the assessment zone.

The conveyor controlling apparatus, wherein
when the conveyor is stopped by the conveyor-controlling module, if the image-analysing module determines based on the object image that the conveyance state of the conveyance object satisfies the forwarding condition, then the conveyor-controlling module restarts the conveyor.

The conveyor controlling apparatus, wherein
the assessment zone includes
   a first assessment zone, and
   a second assessment zone which is provided in a downstream direction with respect to the first assessment zone,
the first assessment zone is an area in which the object image is captured as a first image by the capturing device while the conveyance object is conveyed by the conveyor,
the second assessment zone is an area in which the object image is captured as a second image by the capturing device while the conveyance object is stationary on the conveyor when the conveyor is stopped by the conveyor-controlling module,
the conveyor-controlling module stops the conveyor such that the conveyance object is positioned within the second assessment zone if the image-analysing module determines based on the first image that the conveyance state of the conveyance object does not satisfy the forwarding condition, and
when the conveyor is stopped by the conveyor-controlling module, if the image-analysing module determines based on the second image that the conveyance state of the conveyance object satisfies the forwarding condition, then the conveyor-controlling module restarts the conveyor.

The conveyor controlling apparatus, wherein
the capturing device includes
   a first image-capturing device for capturing the first image, and
   a second image-capturing device for capturing the second image,
the first assessment zone is defined on the conveyor provided in an upstream direction with respect to the first image-capturing device, and
the second assessment zone is defined on the conveyor provided in the downstream direction with respect to the second image-capturing device.

The conveyor controlling apparatus, wherein
the image-analysing module is further configured to implement a learning model,
the learning model defines an assessment standard for the conveyance state, and
the image-analysing module utilises the learning model in the determination of whether the conveyance state of the conveyance object satisfies the forwarding condition.

The conveyor controlling apparatus according to any one of claims 2 to 5, further comprises:
an overriding module for executing an overriding operation, which is an operation to forcibly restart the conveyor, even when the image-analysing module determines based on the object image that the conveyance state of the conveyance object does not satisfy the forwarding condition, in response to an overriding command; and
a training module for updating the learning model based on the overriding command and the object image of the conveyance object when the overriding operation is executed by the overriding module, wherein
the overriding command must include an overriding reason for execution of the overriding operation.

The conveyor controlling apparatus, further comprises:
an intrusion camera as the capturing device for capturing an intrusion image; and
an intrusion-analysing module for determining based on the intrusion image captured by the intrusion camera whether an intrusion state of the keep-out zone satisfies an intrusion condition, wherein
the intrusion image is the environmental image with respect to a keep-out zone which is an area including at least the conveyer,
the intrusion condition, which is the operational condition with respect to the keep-out zone, is a condition that any human is not detected in the keep-out zone,
if the intrusion-analysing module determines that the intrusion state does not satisfy the intrusion condition, then the conveyor-controlling module stops the conveyor.

The conveyor controlling apparatus, wherein
when the conveyor is stopped by the conveyor-controlling module because of the determination by the intrusion-analysing module that the intrusion condition was not satisfied, if the intrusion-analysing module determines based on the intrusion image that the intrusion state satisfies the intrusion condition, then the conveyor-controlling module restarts the conveyor.

The conveyor controlling apparatus, further comprises:
a main body in which has the image-analysing module and the conveyor-controlling module;
a pillar extending upwardly from the main body; and
a head unit, which is provided at a top end of the pillar, housing the capturing device.

A conveyor controlling method for controlling a conveyor in accordance with environment parameters with respect to the conveyor, the method comprises steps of:
preparing a capturing device;
first capturing an environmental image related to the conveyor by the capturing device;
first determining, based on the environmental image captured in the first capturing step, whether an operational condition of the conveyor is satisfied; and
controlling the conveyor based on a result of the determination carried out by the first determining step,
wherein if the determination step determines based on the environmental image that the operational condition is not satisfied, then the controlling step stops the conveyor.

The method, wherein
the first capturing step captures an object image of a conveyance object on the conveyor when the conveyance object is in an assessment zone on the conveyor,
the object image is the environmental image with respect to the conveyance object,
the first determining step determines, based on the object image captured in the first capturing step, whether a conveyance state of the conveyance object satisfies a forwarding condition,
the forwarding condition is the operational condition with respect to the conveyance object, and
if the first determining step determines based on the object image that the conveyance state of the conveyance object does not satisfy the forwarding condition, then the controlling step stops the conveyor such that the conveyance object is positioned within the assessment zone.

The method further comprises steps of:
second capturing the object image of the conveyance object in the assessment zone by the capturing device when the conveyor is stopped by the stopping step;
second determining based on the object image captured in the second capturing step whether the conveyance state of the conveyance object satisfies the forwarding condition; and
restarting the conveyer if the second determining step determines that the conveyance state satisfies the forwarding condition.

The method, wherein
the first capturing step captures the object image as a first image when the conveyance object is within a first assessment zone which is a part of the assessment zone,
the second capturing step captures the object image as a second image when the conveyance object is within a second assessment zone which is another part of the assessment zone and is provided in a downstream direction with respect to the first-assessment zone,
the first determining step is carried out by determining, based on the first image captured in the first capturing step, whether the conveyance state of the conveyance object in the first assessment zone satisfies the forwarding condition,
the second determining step is carried out by determining, based on the second image captured in the second capturing step, whether the conveyance state of the conveyance object in the second assessment zone satisfies the forwarding condition,
the controlling step stops the conveyor such that the conveyance object is positioned within the second assessment zone if the first determining step determines that the conveyance state of the conveyance object in the first assessment zone does not satisfy the forwarding condition, and
the restarting step restarts the conveyer if the second determining step determines based on the second image, when the conveyor is stopped by the stopping step, that the conveyance state of the conveyance object in the second assessment zone satisfies the forwarding condition.

The method, further comprises steps of:
providing a first image-capturing device, as a part of the capturing device, for capturing the first image, and
providing a second image-capturing device, as another part of the capturing device, for capturing the second image, wherein
the first assessment zone is defined on the conveyor provided in an upstream direction with respect to the first image-capturing device, and
the second assessment zone is defined on the conveyor provided in the downstream direction with respect to the second image-capturing device.

The method, further comprises a step of:
providing a learning model, which defines an assessment standard for the conveyance state, being utilised in the determination of whether the conveyance state of the conveyance object satisfies the forwarding condition.

The method, further comprises steps of:
executing an overriding operation, which is an operation forcibly restarts the conveyor, even when the second determining step determines that the conveyance state of the conveyance object in the second assessment zone does not satisfy the forwarding condition, in response to an overriding command; and
updating the learning model based on the overriding command and the object image when the overriding operation is executed by the executing step, wherein
the overriding command must include an overriding reason for execution of the overriding operation.

The method, further comprises steps of:
preparing an intrusion camera as the capturing device for capturing an intrusion image;
intrusion-determining, based on the intrusion image captured by the intrusion camera, whether an intrusion state of the keep-out zone satisfies an intrusion condition; wherein
the intrusion image is the environmental image with respect to a keep-out zone which is an area including at least the conveyer,
the intrusion condition, which is the operational condition with respect to the keep-out zone, is a condition that any human is not detected in the keep-out zone, and
if the intrusion-determining step determines that the intrusion state does not satisfy the intrusion condition, then the controlling stops the conveyor.

The method, wherein
when the conveyor is stopped by the conveyor-controlling module because of the determination by the intrusion-determining step that the intrusion condition was not satisfied, if the intrusion-determining step determines based on the object image that the intrusion state satisfies the intrusion condition, then the conveyor-controlling module restarts the conveyor.

The method, further comprises steps of:
providing a main body;
providing a pillar extending upwardly from the main body; and
providing a head unit, which houses the capturing device, at a top end of the pillar.

### BRIEF DESCRIPTION OF THE DRAWINGS

FIG. 1 is a schematic view showing a conveyor controlling apparatus according to first and third embodiments of the present invention when the apparatus is installed near a belt conveyor of which the conveying direction is in the right direction.

FIG. 2 is a schematic diagram showing a part of an airport in which the conveyor controlling apparatuses according to the first to third embodiments of the present invention are installed.

FIG. 3 is a schematic perspective left-front view showing the conveyor controlling apparatus according to the first embodiment of the present invention.

FIG. 4 is a schematic block diagram showing a configuration of the conveyor controlling apparatus according to the first embodiment of the present invention.

FIG. 5 is a schematic plan view (A₁-A₁ cross-sectional view of FIG. 7) mainly showing a bottom face of a sensor head of the conveyor controlling apparatus according to the first embodiment of the present invention.

FIG. 6 is a schematic front view of the conveyor controlling apparatus according to the first embodiment of the present invention.

FIG. 7 is a schematic rear view of the conveyor controlling apparatus according to the first embodiment of the present invention.

FIG. 8 shows a schematic left view of the conveyor controlling apparatus according to the first embodiment of the present invention when the apparatus is installed adjacent to a belt conveyor.

FIG. 9 is a schematic diagram showing examples of conveyance objects managed by the conveyor controlling apparatuses according to the first to third embodiments of the present invention.

FIG. 10 is a schematic view showing an indication on a touch screen of the conveyor controlling apparatus according to the first to third embodiments of the present invention while an image analysis is in progress.

FIG. 11 is a schematic view showing an example of indication on the touch screen of the conveyor controlling apparatus according to the first to third embodiments of the present invention when the forwarding condition is not satisfied.

FIG. 12 is a schematic view showing an indication on the touch screen of the conveyor controlling apparatus according to the first to third embodiments of the present invention while entering of an overriding reason is awaited.

FIG. 13 is a schematic view showing an example of indication on the touch screen of the conveyor controlling apparatus according to the first to third embodiments of the present invention when the overriding reason is entered.

FIG. 14 is a main flowchart schematically showing an operation of the conveyor controlling apparatus according to the first embodiment of the present invention.

FIG. 15 is a sub-flowchart schematically showing an operation of the conveyor controlling apparatus according to the first embodiment of the present invention.

FIG. 16 is a schematic view showing the conveyor controlling apparatus according to the first and third embodiment of the present invention when the apparatus is installed near the belt conveyor of which the conveying direction is in the left direction.

FIG. 17 is a schematic left view of the conveyor controlling apparatus according to a first variant of the first embodiment of the present invention when the apparatus is installed adjacent to a belt conveyor.

FIG. 18 is a schematic block diagram showing a configuration of the conveyor controlling apparatus according to a second variant of the first embodiment of the present invention.

FIG. 19 is another main flowchart schematically showing an alternative operation of the conveyor controlling apparatus according to the first embodiment of the present invention.

FIG. 20 is a schematic block diagram showing another configuration of the conveyor controlling apparatus according to a third variant of the first embodiment of the present invention, when the conveyor controlling apparatus is installed near a boundary between two conveyors.

FIG. 21 is a schematic view showing a conveyor controlling apparatus according to a second embodiment of the present invention when the apparatus is installed near a belt conveyor of which a conveyance object is in a first upstream-assessment zone.

FIG. 22 is a schematic view showing a conveyor controlling apparatus according to the second embodiment of the present invention when the apparatus is installed near a belt conveyor of which a conveyance object is in a second upstream-assessment zone.

FIG. 23 is a schematic block diagram of the conveyor controlling apparatus according to the second embodiment of the present invention.

FIG. 24 is a schematic front view of the conveyor controlling apparatus according to the second embodiment of the present invention.

FIG. 25 shows a schematic left view of the conveyor controlling apparatus according to the second embodiment of the present invention when the apparatus is installed adjacent to a belt conveyor.

FIG. 26 is a schematic perspective left-back view partially showing the conveyor controlling apparatus according to the second embodiment of the present invention.

FIG. 27 is a schematic plan view showing a bottom face of a head unit of the conveyor controlling apparatus according to the second embodiment of the present invention.

FIG. 28 is a schematic view showing an intrusion image captured by the conveyor controlling apparatus according to the first to third embodiments of the present invention.

FIG. 29 is a schematic view showing an intrusion image captured by the conveyor controlling apparatuses according to the first to third embodiments of the present invention, showing a case where a keep-out zone is reflected in the intrusion image.

FIG. 30 is a main flowchart schematically showing an operation of the conveyor controlling apparatus according to the second embodiment of the present invention.

FIG. 31(a) is a schematic diagram showing the operation of the conveyor controlling apparatus according to the second embodiment of the present invention, showing a state immediately after a part of a conveyance object enters a first assessment zone.

FIG. 31(b) is a schematic diagram showing the operation of the conveyor controlling apparatus according to the second embodiment of the present invention, showing a state in which entire conveyance object enters the first assessment zone.

FIG. 31(c) is a schematic diagram showing the operation of the conveyor controlling apparatus according to the second embodiment of the present invention, showing a state in which the conveyance object is stationary in a second assessment zone.

FIG. 31(d) is a schematic diagram showing the operation of the conveyor controlling apparatus according to the second embodiment of the present invention, showing a state in which the conveyance object is further forwarded in a downstream direction from the second assessment zone.

FIG. 32 is a flowchart schematically showing an operation of the conveyor controlling apparatuses according to the second and third embodiments of the present invention, showing a need-of-care control.

FIG. 33 is a flowchart schematically showing an operation of the conveyor controlling apparatuses according to the second and third embodiments of the present invention, showing an intrusion control.

FIG. 34 is a schematic view showing an example of display on a display unit of the conveyor controlling apparatuses according to the first to third embodiments of the present invention.

FIG. 35 is a schematic front view of the conveyor controlling apparatus according to the third embodiment of the present invention.

FIG. 36 is a schematic plan view showing a bottom face of a head unit of the conveyor controlling apparatus according to the third embodiment of the present invention.

FIG. 37 is a schematic block diagram of the conveyor controlling apparatus according to the third embodiment of the present invention.

FIG. 38(a) is a schematic diagram showing the operation of the conveyor controlling apparatus according to the third embodiment of the present invention, showing a state immediately after a part of a conveyance object enters a first assessment zone.

FIG. 38(b) is a schematic diagram showing the operation of the conveyor controlling apparatus according to the third embodiment of the present invention, showing a state in which entire conveyance object enters the first assessment zone.

FIG. 38(c) is a schematic diagram showing the operation of the conveyor controlling apparatus according to the third embodiment of the present invention, showing a state in which the conveyance object is stationary in a second assessment zone.

FIG. 38(d) is a schematic diagram showing the operation of the conveyor controlling apparatus according to the third embodiment of the present invention, showing a state in which the conveyance object is further forwarded in a downstream direction from the second assessment zone.

FIG. 39 is a main flowchart schematically showing an operation of the conveyor controlling apparatus according to the third embodiment of the present invention.

FIG. 40 is an example of a schematic list of rejection categories may be used by the conveyor controlling apparatuses according to the first to third embodiments of the present invention.

### DESCRIPTION OF THE PREFERRED EMBODIMENTS

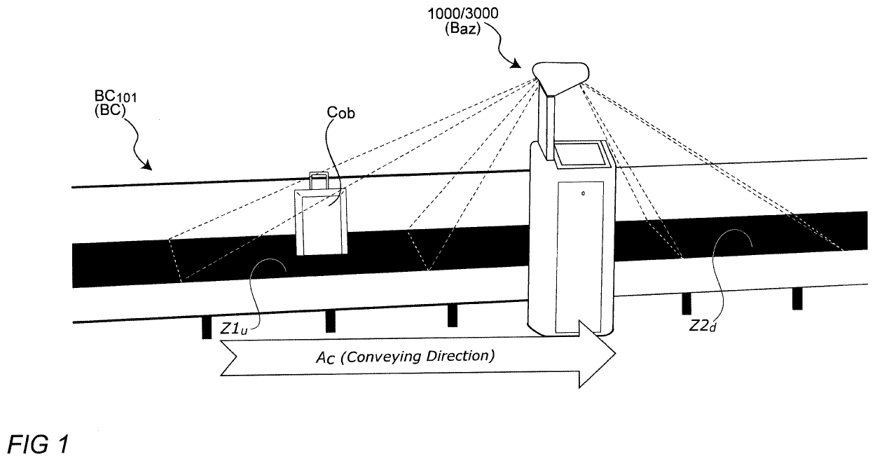

The first embodiment of the present invention will now be described with reference to the accompanying main drawings FIGS. 1 to 20.

As shown in FIG. 1, a conveyor supervisor 1000 (conveyor controlling apparatus Baz), which is installed in the vicinity of a belt conveyor BC, assesses whether a conveyance state of the conveyance object Cob on the belt conveyor BC satisfies a predetermined forwarding condition. The definition of the ‘conveyance object’ Cob includes all kinds of objects on the belt conveyor BC.

That is, not only ordinary objects (e.g. bags or parcels), which are normally carried by the belt conveyor BC, but also other non-ordinary objects, which should theoretically not be carried by the belt conveyor BC, shall also be included in the definition of ‘conveyance object’ Cob.

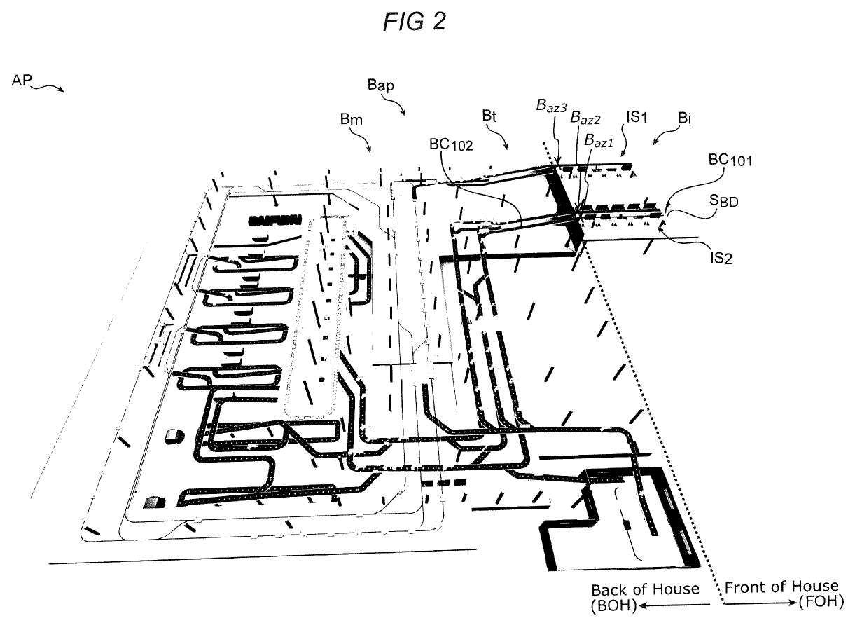

The conveyor supervisor 1000 is designed for an airport AP. The airport AP has a non-restricted area (so-called Front of House (FOH)) and a restricted area (so-called Back of House (BOH)) as shown in FIG. 2. The conveyor supervisor 1000 can be utilised in both the FOH and the BOH. In this airport AP, each of the conveyor supervisors 1000 is installed at the points shown as “B_{az1}”, “B_{az2}”, and “B_{az3}” in FIG. 2, but in the present embodiment, one of the conveyor supervisors 1000 installed in the place shown as “B_{az1}” in FIG. 2 will be described.

An automatic baggage handling system (BHS) Bap installed in the airport AP mainly has an introduction part Bi, a main part Bm, and a transition part Bt.

The introduction part Bi has a group of conveyors such as weighing conveyors (not shown in FIGs), holding conveyors (not shown in FIGs) and collector conveyors BC₁₀₁ installed in first and second islands IS1 and IS2 provided in the FOH in the airport AP. Each of the first and second islands IS1 and IS2 has a plurality of self-baggage drop machines S_{BD}.

Each self-baggage drop machine S_{BD} has a weighing conveyor.

Each of the holding conveyors, which is provided at a downstream side of each of the weighing conveyors, receives checked-luggage (conveyance object Cob) forwarded from the weighing conveyor, and automatically drops the forwarded checked-luggage into the collector conveyor BC₁₀₁ at an appropriate timing.

The collector conveyor BC₁₀₁ is a belt conveyor that continuously runs substantially at a constant speed (e.g. 30 m/min) for conveying the checked-luggage dropped from the holding conveyor to the downstream-side.

The main part Bm is the core part of the automatic baggage handling system Bap provided in the BOH of the airport AP. The main part Bm has a group of conveyors such as main conveyors, tilt-tray conveyors, and make-up conveyors.

The transition part Bt, which is a part provided between the introduction part Bi and the main part Bm in the BOH of the airport AP, has a transport conveyor BC₁₀₂ installed near an inlet of BOH.

The transport conveyor BC₁₀₂, which is a belt conveyor disposed between a downstream end of the introduction part Bi and an upstream end of the main part Bm, forwards the checked-luggage (conveyance object Cob) sent from the collector conveyor BC₁₀₁ to the main part Bm.

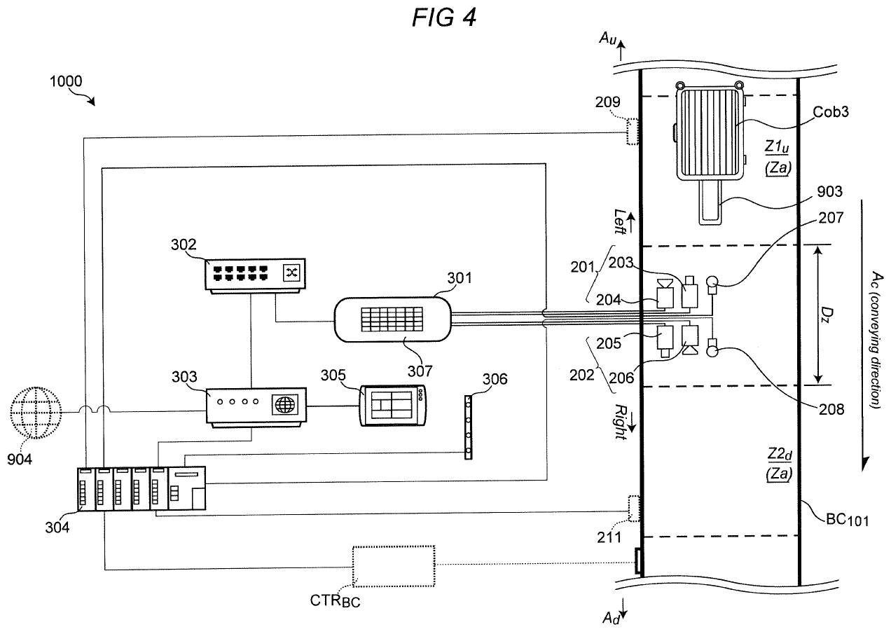

Each of the conveyors of the automatic baggage handling system Bap is controlled by a conveyor controller CTR_{BC} (see FIG. 4).

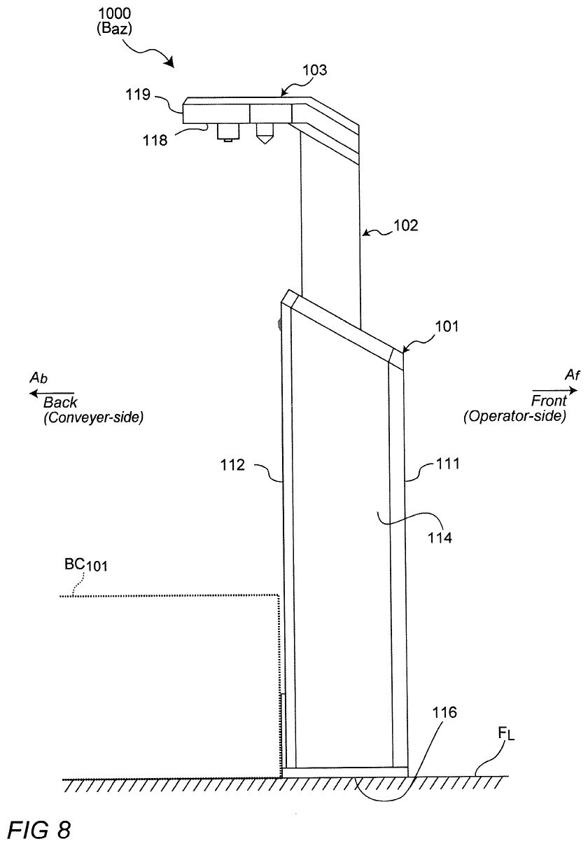

The conveyor supervisor 1000 is installed in a position abutting onto the collector conveyor BC₁₀₁ (see FIGS. 1 and 8). The conveyor supervisor 1000 assesses whether a conveyance state of the conveyance object Cob carried by the collector conveyor BC₁₀₁ satisfies a forwarding condition. The forwarding condition includes specific requirements (e.g. size, orientation, and posture of baggage) in terms of the capability of the automatic baggage handling system Bap.

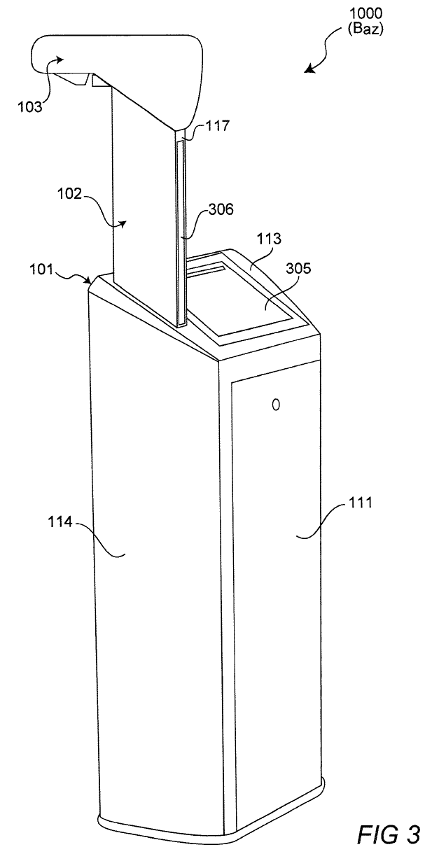

As shown in FIGS. 3, 6, 7, and 8, the conveyor supervisor 1000 is mainly comprises a main body 101, a pillar 102, and a sensor head (head unit) 103.

The main body 101 is a pedestal portion of which a bottom face 116 is placed on a floor F_{L} and vertically extends upwards. Further, as shown in FIG. 4, a primary AI computer 301, a secondary AI computer 308, a network hub 302, a system computer 303, and an I/O controller 304 are included in the main body 101.

A top face 113 of the main body 101 is formed as a plane extending diagonally downward from a back face 112 to a front face 111. A touch screen (display unit) 305 is provided on the top face 113.

The pillar 102 is a metal member extending upward from the main body 101. A status indicator 306 is provided on a front face 117 of the pillar 102.

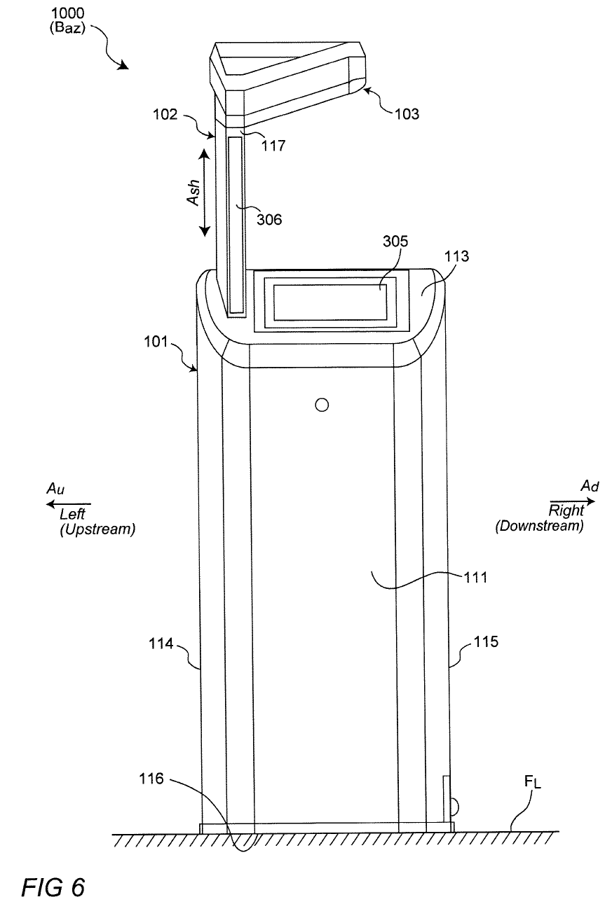

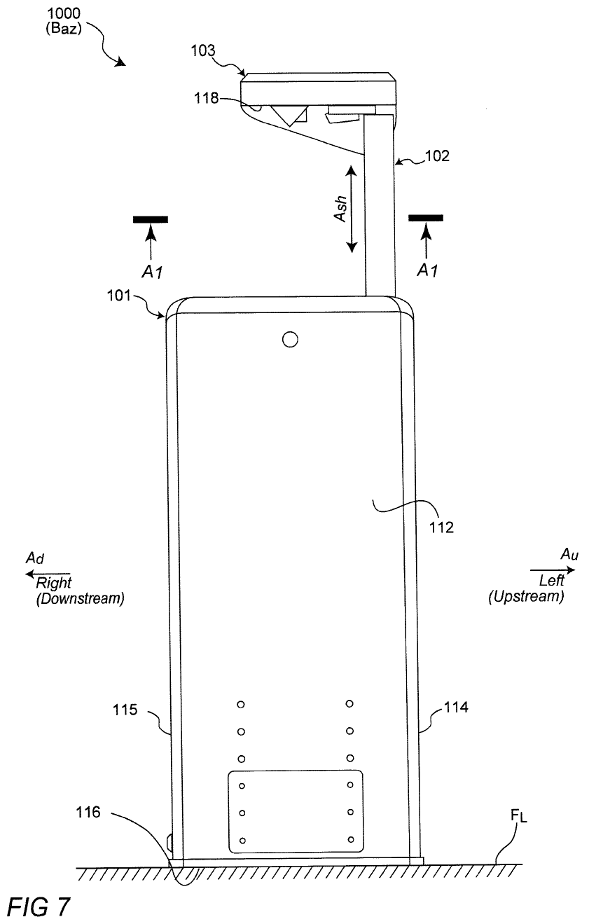

Further, the pillar 102 is slidably fixed to the main body 101 so that the height of the sensor head 103 is adjustable as shown by the bi-directional arrow Ash in FIGS. 6 and 7.

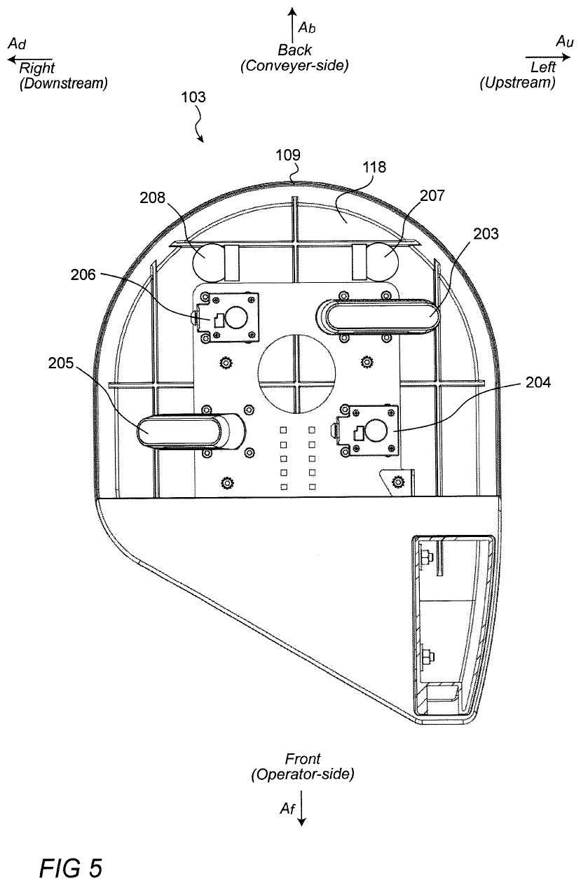

The sensor head 103 is an assembly unit fixed to the top end of the pillar 102. As shown in FIG. 5, a left three-dimensional camera (capturing device/upstream capturing device 201) 203, a left RGB camera (capturing device/upstream capturing device 201) 204, a left light (upstream lighting device) 207, a right three-dimensional camera (capturing device/downstream capturing device 202) 205, a right RGB camera (capturing device/downstream capturing device 202) 206, and a right light (downstream lighting device) 208 are fixed onto a bottom face 118 of the sensor head 103.

Each of the left RGB camera 204 and the right RGB camera 206 is a Global Shutter RGB type camera with a fixed manual focus lens.

Further, as shown in FIG. 8, a tip end 119 of the sensor head 103 projects further behind the back face 112 of the main body 101. Hence, when the conveyor supervisor 1000 is installed in such a manner that the back face 112 abuts onto the collector conveyor BC₁₀₁, the equipment provided under the bottom face 118 of the sensor head 103 is located above the collector conveyor BC₁₀₁.

Each of the left three-dimensional camera 203 and the left RGB camera 204 captures an image of the conveyance object Cob as an upstream image (first image) when the conveyance object Cob is in an first upstream-assessment zone (upstream assessment zone) Z₁ᵤ on the collector conveyor BC₁₀₁ and while the conveyance object Cob is conveyed by the collector conveyor BC₁₀₁ in a direction (see the arrow Ac in FIG. 4) towards the left three-dimensional camera 203 and the left RGB camera 204.

The upstream image captured by the left three-dimensional camera 203 is transmitted in real time to the primary AI computer 301 as data processed three-dimensionally (3D point cloud data) about the conveyance object Cob. The upstream image captured by the left RGB camera 204 is simply forwarded in real time to the primary AI computer 301 as raw data that is not subjected to special processing.

As shown in FIG. 4, each of the right three-dimensional camera 205 and the right RGB camera 206 captures an image of the conveyance object Cob in a second downstream-assessment zone (downstream assessment zone) Z_{2d} on the collector conveyor BC₁₀₁ as a downstream image (second image).

The downstream image captured by the right three-dimensional camera 205 is transmitted in real time to the primary AI computer 301 as data processed three-dimensionally (3D point cloud data) about the conveyance object Cob. The downstream image captured by the right RGB camera 206 is simply forwarded in real time to the primary AI computer 301 as raw data that is not subjected to special processing.

As shown in FIG. 5, the left three-dimensional camera 203 and the right RGB camera 206 are substantially disposed back to back under the bottom face 118 of the sensor head 103. In addition, the left RGB 204 and the right three-dimensional camera 205 are substantially disposed back to back under the bottom face 118 of the sensor head 103.

In the present embodiment, the conveying direction Ac of the collector conveyor BC₁₀₁ is the right direction (see FIG. 1) with respect to the conveyor supervisor 1000. Accordingly, lenses of the left three-dimensional camera 203 and the left RGB camera 204 both face towards an upstream direction (see an arrow Au in FIG. 5). On the other hand, lenses of the right three-dimensional camera 205 and the right RGB camera 206 both face towards a downstream direction (see an arrow Ad in FIG. 5).

As shown in FIGS. 1 and 4, the first upstream-assessment zone Z₁ᵤ on the collector conveyor BC₁₀₁ is a virtual area that approximately corresponds to a photographable area of the cameras towards the upstream direction Au (i.e. the left three-dimensional camera 203 and the left RGB camera 204 in this embodiment).

The second downstream-assessment zone Z_{2d} on the collector conveyor BC₁₀₁ is another virtual area that approximately corresponds to a photographable area of the cameras towards the downstream direction Ad (i.e. the right three-dimensional camera 205 and the right RGB camera 206 in this embodiment).

Further, the first upstream-assessment zone Z₁ᵤ is provided in the upstream direction Au (i.e. the left side in the present embodiment) with respect to the sensor head 103. On the other hand, the second downstream-assessment zone Z_{2d} is provided in the downstream direction Ad (i.e. the right side in the present embodiment) with respect to the sensor head 103.

This means that the first upstream-assessment zone Z₁ᵤ is set in the upstream direction Au with respect to the second downstream-assessment zone Z_{2d}. The second downstream-assessment zone Z_{2d} is set in the downstream direction Ad with respect to the first upstream-assessment zone Z₁ᵤ.

Each of the first upstream-assessment zone Z₁ᵤ and the second downstream-assessment zone Z_{2d} is set as a stationary area regardless of running and stopping of the collector conveyor BC₁₀₁.

A zone-separation distance (see a sign Dz in FIG. 4), which is a gap distance between the first upstream-assessment zone Z₁ᵤ and the second downstream-assessment zone Z_{2d}, is set in accordance with the processing power of the primary AI computer 301.

The zone-separation distance Dz can be adjusted by changing the height of the sensor head 103, as shown by the arrow Ash in FIG. 6.

In addition, the zone-separation distance Dz can be adjusted by individually changing mounting angle of the left three-dimensional camera 203, the left RGB camera 204, the right three-dimensional camera 205, and the right RGB camera 206, with respect to the sensor head 103.

For example, if the processing power of the primary AI computer 301 is relatively higher, then the zone-separation distance Dz may be set relatively shorter. On the other hand, if the processing power of the primary AI computer 301 is relatively lower, then the zone-separation distance Dz may be set relatively longer.

As shown in FIG. 5, the left light 207 is a lighting unit that illuminates the first upstream-assessment zone Z₁ᵤ so that the left three-dimensional camera 203 and the left RGB camera 204 clearly capture the upstream image of the conveyance object Cob.

The right light 208 is another lighting unit that illuminates the second downstream-assessment zone Z_{2d} so that the right three-dimensional camera 205 and the right RGB camera 206 clearly capture the downstream image of the conveyance object Cob.

As shown in FIG. 4, the primary AI computer (image-analysing module) 301 is a single-board computer that is capable of neural network processing based on image data. The primary AI computer 301 is communicably connected to the network hub 302.

The primary AI computer 301 is also communicably connected to each of the left three-dimensional camera 203, the left RGB camera 204, the right three-dimensional camera 205, and the right RGB camera 206. The AI computer 301 executes image-processing applications for image classification, object detection in images and division of images, in addition to the neural network processing.

Based on a learning model 307 stored in a storage device of the primary AI computer 301, the primary AI computer 301 analyses the upstream image and/or the downstream image, and recognises the ‘conveyance state’ with regard to the conveyance object Cob on the collector conveyor BC₁₀₁. Further, the primary AI computer 301 determines whether the recognised conveyance state satisfies the ‘forwarding condition’ of the automatic baggage handling system Bap.

In the meantime, the determination on the conveyance state of the conveyance object Cob in the first upstream-assessment zone Z₁ is referred to as the ‘primary determination’. On the other hand, the determination on the conveyance state of the conveyance object Cob in the second downstream-assessment zone Z_{2d} is referred to as the ‘secondary determination’.

The learning model 307 defines an assessment standard. Specifically, the learning model 307 is a machine learning model generated based on a vast amount of raw data (training data), in which a number of conveyance objects Cob are photographed individually, and a learning data set corresponding to the factors of the conveyance objects Cob. The learning model 307 is stored in the storage device of the primary AI computer 301.

In addition, the primary AI computer 301 (training module) updates the learning model 307, in response to an overriding command containing an overriding reason entered by an operator via the touch screen 305 based on the entered overriding reason and the upstream image and/or the downstream image.

In the meantime, the ‘conveyance state’ includes various factors with regard to the conveyance object Cob (e.g. dimensions, orientation, type, condition of accessories, presence or absence of overlapping, distance from other conveyance objects Cob, presence or absence of transport tub, open/close state, presence or absence of baggage tag, and so on).

For example, when a conveyance object Cob is conveyed by the collector conveyor BC₁₀₁, the primary AI computer 301, based on the learning model 307 and the upstream image and/or the downstream image, recognises the type of the conveyance object Cob as a suitcase (hard bags), a duffel bag (soft bags), a backpack (soft bags), a sports bag (soft bags), or others.

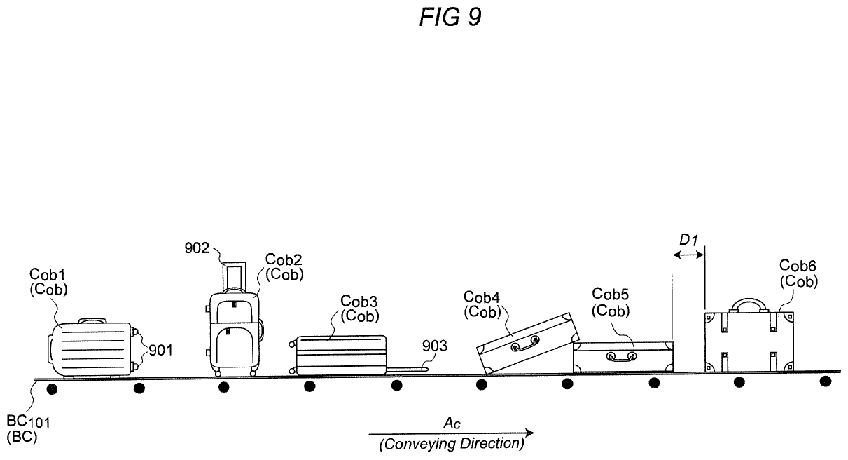

In addition, when a conveyance object Cob has wheels (movable parts), the primary AI computer 301 recognises whether the conveying direction Ac of the collector conveyor BC₁₀₁ and a projecting direction of the wheels protrude from the conveyance object Cob are substantially the same. Further, the primary AI computer 301 recognises whether the orientation of the conveyance object Cob is either upright or lying flat. As shown in FIG. 9, wheels 901 of a suitcase Cob1 protrudes towards in a direction that is the same as the conveying direction Ac of the collector conveyor BC₁₀₁.

Further, the primary AI computer 301 recognises whether an auxiliary piece such as a handle (movable parts) of a conveyance object Cob is appropriately stowed in the conveyance object Cob. In this regard, FIG. 9 shows a handle 902 of a suitcase Cob2 is extended and not properly retracted into the suitcase Cob2, and orientation of the suitcase Cob2 is upright.

In addition, FIG. 9 shows a suitcase Cob3 that is lying on the collector conveyor BC₁₀₁ (i.e. the orientation of the suitcase Cob3 is proper), but a handle 903 of the suitcase Cob3 is extended and not properly retracted into the suitcase Cob3.

The primary AI computer 301 also recognises whether one conveyance object Cob overlaps another conveyance object Cob (see suitcases Cob4 and Cob5 in FIG. 9).

In addition, the primary AI computer 301 recognises whether a distance (see the arrow D1 in FIG. 9) between one conveyance object Cob and another conveyance object Cob is shorter than a threshold distance.

In addition, if a baggage tag is affixed to a conveyance object Cob, the primary AI computer 301 recognises the affixed baggage tag.

In addition, if there is relatively large damage to a conveyance object Cob, the primary AI computer 301 recognises the damage on the conveyance object Cob.

Further, the primary AI computer 301 recognises whether a conveyance object Cob is placed in a transport tub.

The primary AI computer 301 also recognises whether a shoulder strap is properly bundled if a conveyance object Cob has the shoulder strap.

The primary AI computer 301 also recognises whether a conveyance object Cob is properly closed (i.e. the open/close state of the conveyance object Cob).

That is, the primary AI computer 301 assesses a conveyance object Cob as an ‘improper-state object’, which is an object that is not in a state that can be conveyed, if the primary AI computer 301 recognises at least one of:
(i) the size of the conveyance object Cob exceeds the prescribed size (height, width and depth); (ii) the orientation of the conveyance object Cob is upright;
(iii) the conveying direction Ac of the collector conveyor BC₁₀₁ and the projecting direction of wheels of the conveyance object Cob are substantially the same;
(iv) a handle is not appropriately retracted in the conveyance object Cob;
(v) there is no baggage tag affixed to the conveyance object Cob;
(vi) the conveyance object Cob is recognised as a soft bag that is not placed in a transport tub; (vii) a shoulder strap of the conveyance object Cob is not properly bundled; and
(viii) the conveyance object Cob is not properly closed.

The primary AI computer 301 also assesses a conveyance object Cob as the ‘improper-state object’ if the primary AI computer 301 recognises that there are extraneous items (i.e. passports, books, magazines, documents and so on) left on the conveyance object Cob on the collector conveyor BC₁₀₁.

In addition, the primary AI computer 301 assesses a conveyance object Cob on the collector conveyor BC₁₀₁ as an ‘unknown object’, if the primary AI computer 301 cannot recognise the conveyance object Cob.

Further, the primary AI computer 301 determines that the conveyance state of the conveyance object Cob on the collector conveyor BC₁₀₁ does not meets the forwarding condition, if the conveyance object Cob is assessed as at least one of the ‘improper-state object’ and the ‘unknown object’. On the other hand, the primary AI computer 301 determines that the conveyance state of the conveyance object Cob on the collector conveyor BC₁₀₁ meets the forwarding condition, if the conveyance object Cob is assessed as neither the ‘improper-state object’ nor the ‘unknown object’.

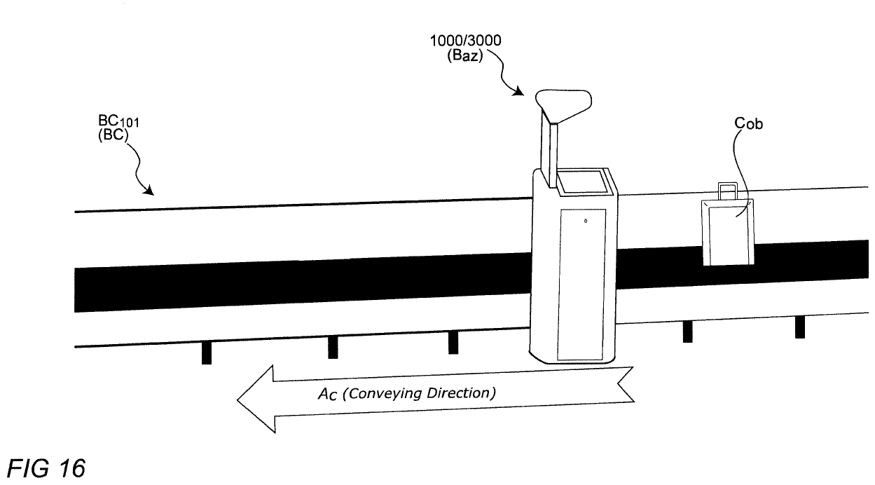

The primary AI computer 301 and the system computer 303 ascertain the conveying direction Ac of the collector conveyor BC₁₀₁ based on the installation information entered by an operator through the touch screen 305. Alternatively, the primary AI computer 301 and the system computer 303 may determine that the conveying direction Ac of the collector conveyor BC₁₀₁ is either rightwards (see FIG. 1) or leftwards (see FIG. 16) based on the upstream image and/or the downstream image.

As shown in FIG. 4, the network hub 302 is a network switch that supports the TCP/IP protocol having power-over-Ethernet (POE) function. The network hub 302 is communicably connected to each of the primary AI computer 301, the secondary AI computer 308, and the system computer 303.

The system computer 303 is a computer that holistically control the conveyor supervisor 1000. The system computer 303 is communicably connected to each of the network hub 302, the I/O controller 304, and the touch screen 305.

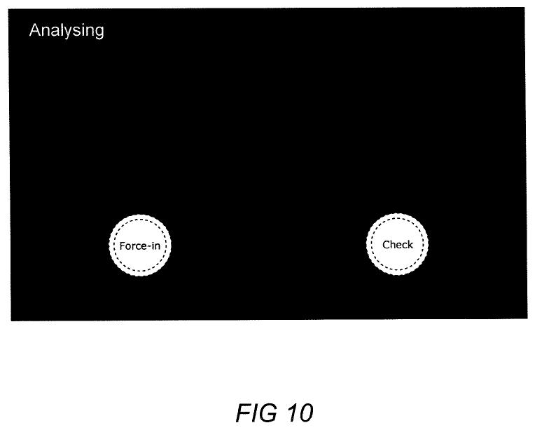

The system computer 303 displays the processing status by the primary AI computer 301 on the touch screen 305. For instance, FIG. 10 shows an indication on the touch screen 305 while the image analysis process by the primary AI computer 301 is ongoing.

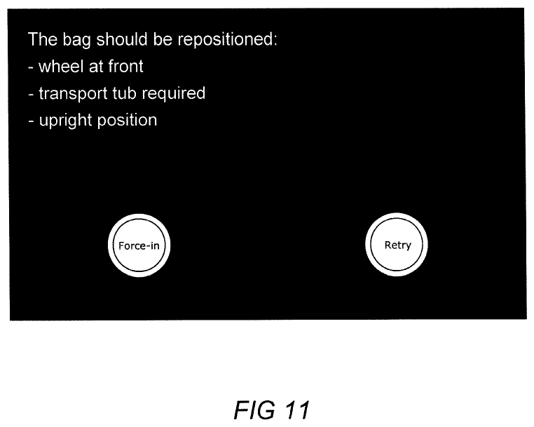

When the primary AI computer 301 determines that the conveyance state of the conveyance object Cob does not meet the forwarding condition, then the system computer 303 displays the problems of the conveyance state on the touch screen 305. For example, an indication on the touch screen 305 is shown in FIG. 11 when the primary AI computer 301 recognises: wheels of the conveyance object Cob projects to the conveying direction Ac; the conveyance object Cob requires a transport tub; and orientation of the conveyance object Cob is upright.

The system computer 303 has an external-communication module (remote accessing module) which is not shown in the FIGs. The system computer 303 is communicably connected to the Internet 904 via the external-communication module. This allows remote operators to connect to the system computer 303 via the Internet 904 and an external-communication module in order to remotely control the conveyor supervisor 1000.

The external-communication module (communication module) of the system computer 303 also communicates with other external systems (e.g. SCADA systems, systems under the control of the International Air Transport Association (IATA), and other cargo systems).

The system computer 303 has a diagnosing module (diagnosing module) that executes a diagnostic program for self-diagnosing the conveyor supervisor 1000.

The system computer 303 also has a logging module (logging module) that records the activity of the conveyor supervisor 1000.

In the meantime, the diagnostic module and the logging module are not shown in the FIGs.

The system computer 303 turns on the status indicator (alarm device) 306 via the I/O controller 304 in accordance with the results of the primary and secondary determinations performed by the primary AI computer 301. As a result, it is possible to visually notify operators of the conveyance state of the conveyance object Cob.

The touch screen 305 is an interface device provided on the top face 113 of the main body 101. The touch screen 305 is communicably connected to the system computer 303. The touch screen 305 visually notifies various information to an operator in accordance with the commands from the system computer 303. Further, the touch screen 305 receives inputs from the operator and forward the inputs entered by the operator to the system computer 303.

The I/O controller 304 is a control unit that is communicably connected to the system computer 303 and the conveyor controller CTR_{BC} of the automatic baggage handling system Bap. Hence, the I/O controller 304 controls the collector conveyor BC₁₀₁ via the conveyor controller CTR_{BC} in accordance with control commands received from the system computer 303.

That is, the collector conveyor BC₁₀₁ is controlled by the I/O controller 304, which works in accordance with the control commands transmitted by the system computer 303 according to the results of the primary and/or secondary determinations.

If the primary AI computer 301 determines that the conveyance state of the conveyance object Cob, which is recognised based on the learning model 307 and the upstream image, ‘satisfy’ (i.e. when the primary determination is a positive result), then the system computer 303 does not actively control over the I/O controller 304. Hence, in this case, the collector conveyor BC₁₀₁ continues normal operation. As a result, the conveyance object Cob passes through the second downstream-assessment zone Z_{2d}, and continues travelling in the downstream direction Ad.

On the other hand, if the primary AI computer 301 determines that the conveyance state of the conveyance object Cob, which is recognised based on the learning model 307 and the upstream image, ‘does not satisfy’ (i.e. when the primary determination is a negative result), the system computer 303, via the I/O controller 304 and the conveyor controller CTR_{BC}, controls the collector conveyor BC₁₀₁ in such a matter that the conveyance object Cob is stopped in the second downstream-assessment zone Z_{2d} second downstream-assessment zone Z_{2d}. This allows the right three-dimensional camera 205 and the right RGB camera 206 to capture the downstream image of the conveyance object Cob in a stationary state.

If the primary AI computer 301 determines that the conveyance state of the conveyance object Cob, which is recognised based on the learning model 307 and the downstream image, ‘does not satisfy’ (i.e. when the secondary determination is a negative result), the system computer 303 does not actively control over the I/O controller 304. Hence, in this case, the stationary state of the collector conveyor BC₁₀₁ continues, so the conveyance object Cob is held as it is in the second downstream-assessment zone Z_{2d} second downstream-assessment zone Z_{2d}.

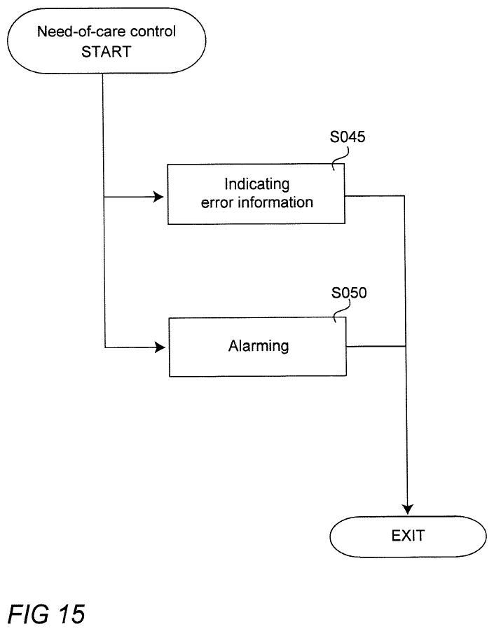

Further, if the secondary determination is a negative result, the system computer 303 executes a ‘need-of-care control’. This need-of-care control includes a control for indicating the problems of the conveyance state of the conveyance object Cob on the touch screen 305, and another control for turning on the status indicator 306. Details of this need-of-care control will be described later using FIG. 15.

On the other hand, if the primary AI computer 301 determines that the conveyance state of the conveyance object Cob, which is recognised based on the learning model 307 and the downstream image, is ‘satisfactory’ (i.e. when the secondary determination is a positive result), then the system computer 303 sends a resume signal to the I/O controller 304. Afterwards, the I/O controller 304 restarts, via the conveyor controller CTR_{BC}, the collector conveyor BC₁₀₁ in the stationary state in response to the resume signal received from the system computer 303. As a result, the conveyance object Cob on the collector conveyor BC₁₀₁ travels in the downstream direction Ad.

In the meantime, a situation in which the conveyance state of the conveyance object Cob does not satisfy the forwarding condition in the first upstream-assessment zone Z₁ᵤ, but then satisfies the forwarding condition in the second downstream-assessment zone Z_{2d}, it could generally be assumed that the conveyance condition of the conveyance object Cob has been corrected with an action taken by an operator because of executing the need-of-care control which enables the operator to recognise that the conveyance object Cob held in the second downstream-assessment zone Z_{2d} does not meet the forwarding condition.

However, even if the primary AI computer 301 determines that the conveyance state of the conveyance object Cob does not meet the forwarding condition in the secondary determination, the I/O controller 304 receives the resume signal from the system computer (overriding module) 303 when the system computer 303 executes an ‘overriding operation’.

This overriding operation is an operation that is executed when an input of the overriding command to the touch screen 305 is completed. That is, when the input of the overriding command to the touch screen 305 is completed, the system computer 303 transmits the resume signal to the I/O controller 304. Then, the I/O controller 304, which received the resume signal, resumes the collector conveyor BC₁₀₁ in the stationary state via the conveyor controller CTR_{BC} so that the conveyance object Cob travels in the downstream direction Ad.

In other words, this overriding operation is carried out under a situation where the primary AI computer 301 determines that the conveyance state of the conveyance object Cob suspended in the second downstream-assessment zone Z_{2d} still does not meet the forwarding condition, but an operator completed the input of the overriding command into the touch screen 305.

Then, when this overriding operation is executed, the system computer 303 restarts the collector conveyor BC₁₀₁ via the I/O controller 304 and the conveyor controller CTR_{BC} in order to send the conveyance object Cob in the downstream direction Ad.

Nevertheless, prior to executing the overriding operation (i.e. for completion of inputting the overriding command), it is required to input a reason (overriding reason) into the touch screen 305.

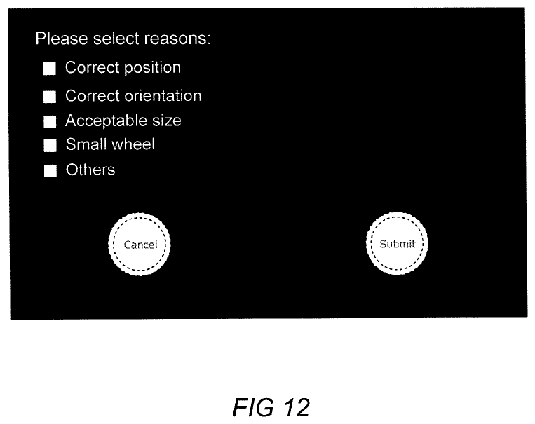

As shown in FIG. 12, each of the check boxes for corresponding to the problem of the conveyance state of the conveyance object Cob is indicated on the touch screen 305. Accordingly, an operator, who saw the indication on the touch screen 305, checks an actual state of the conveyance object Cob, which is temporarily stopped in the second downstream-assessment zone Z_{2d}, and input the overriding reasons into the touch screen 305 by entering ticks into the corresponding checkboxes.

For example, assuming that the primary AI computer 301 recognises that the size of a conveyance object Cob held in the second downstream-assessment zone Z_{2d} exceeds the predetermined specified size (height, width and depth), as a result, the primary AI computer 301 determines that the conveyance object Cob is deemed as an improper-state object, and therefore the primary AI computer 301 determines that the conveyance state of the conveyance object Cob does not satisfy the forwarding condition, but the operator has confirmed that the size of the conveyance object Cob stopped in the second downstream-assessment zone Z_{2d} is actually within the predetermined specified dimensions.

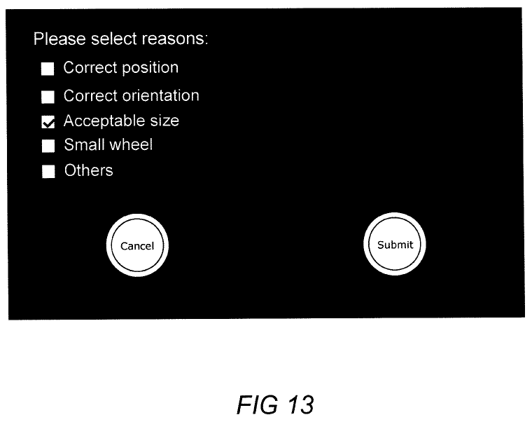

In this case, the operator enters a tick into the check box of ‘Acceptable size’, which is one of the overriding reasons displayed on the touch screen 305 as shown in FIG. 13, and then touches a “Submit” button indicated on the touch screen 305, otherwise the overriding operation will not be executed. In other words, it is mandatory to include the overriding reason to complete inputting the overriding command.

When the overriding operation is executed, the system computer 303 forwards the overriding reason entered into the touch screen 305 to the primary AI computer 301. The primary AI computer 301, which received this overriding reason, updates the learning model 307 based on the upstream and downstream images corresponding to the conveyance object Cob subjected to the overriding operation and the overriding reason received from the system computer 303.

The states of the learning model 307 can be restored as needed. For example, backup data of the learning model 307 may be periodically saved and stored in the storage device of the primary AI computer 301. This affords the ability to restore the learning model 307 based on the backup data of any restore points. This is particularly useful in the event of any ‘incorrect training data’ which had been fed into and has corrupted the learning model 307.

Alternatively, more simply, a factory default version of backup data of the learning model 307 may be stored in the storage device of the primary AI computer 301. According to this arrangement, the learning model 307 can be restored to the factory default state at any time.

In other words, even if operators repeatedly enter the overriding reason incorrectly, the learning model 307 can be corrected by restoring the learning model 307 as appropriate.

The collector conveyor BC₁₀₁ has a first photo-eye sensor 209 near the first upstream-assessment zone Z₁ᵤ. Further, the collector conveyor BC₁₀₁ has a second photo-eye sensor 211 near the second downstream-assessment zone Z_{2d}.

Each of the first and second photo-eye sensors 209 and 211 is communicably connected to the I/O controller 304.

Hence, the system computer 303 and the primary AI computer 301 may detect the conveyance object Cob in the first upstream-assessment zone Z₁ᵤ by the first photo-eye sensor 209.

Likewise, the system computer 303 and the primary AI computer 301 may detect the conveyance object Cob in the second downstream-assessment zone Z_{2d} by the second photo-eye sensor 211.

With the above-mentioned arrangement, the conveyor controlling apparatus according to the first embodiment of the present invention provides the following advantages.

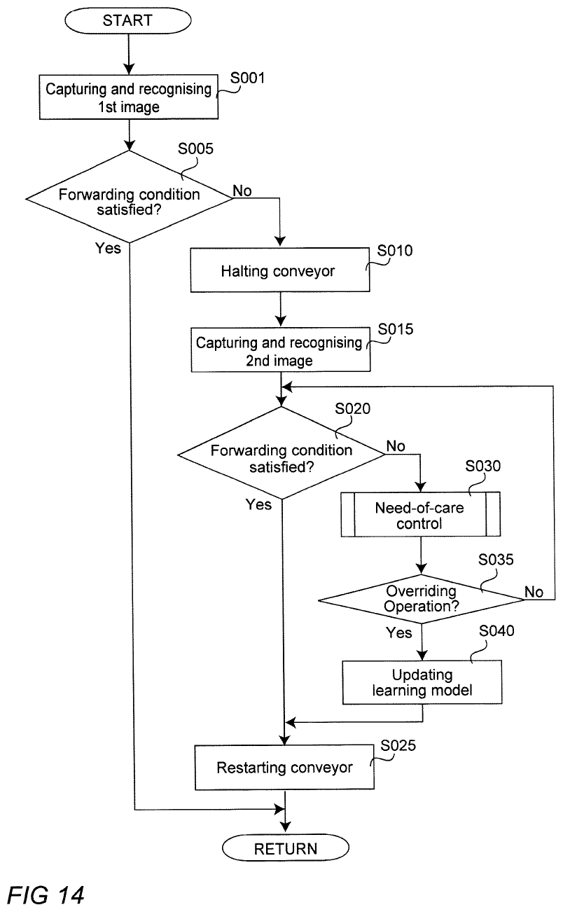

The assessment of the conveyance object Cob by the conveyor supervisor 1000 is mainly performed in accordance with a main flowchart shown in FIG. 14.

At step S001, when a conveyance object Cob, which is conveyed in the downstream direction Ad by the collector conveyor BC₁₀₁, enters into the first upstream-assessment zone Z₁ᵤ, then the left light 207 illuminates the first upstream-assessment zone Z₁ᵤ and the left three-dimensional camera 203 and the left RGB camera 204 capture an image of the conveyance object Cob as the upstream image.

Then, the primary AI computer 301 performs the image recognition using the learning model 307 for the captured upstream image.

Afterwards, at step S005, the primary AI computer 301 determines whether the conveyance state of the conveyance object Cob on the collector conveyor BC₁₀₁ satisfies the forwarding condition based on the recognition result of the upstream image.

If the result of the determination at step S005 is positive (see Yes route from step S005), the system computer 303 does not actively control the conveyor controller CTR_{BC}. That is, in this case, the collector conveyor BC₁₀₁ continues normal operation. Accordingly, the conveyance object Cob on the collector conveyor BC₁₀₁ passes through the second downstream-assessment zone Z_{2d} and is further carried in the downstream direction Ad.

On the other hand, if the result of the decision at step S005 is negative (see No route from step S005), the system computer 303 instructs the conveyor controller CTR_{BC} so that the conveyance object Cob on the collector conveyor BC₁₀₁ is stopped within the second downstream-assessment zone Z_{2d} (step S010).

At step S015, an image of the conveyance object Cob stationary in the second downstream-assessment zone Z_{2d} is captured as the downstream image by the right three-dimensional camera 205 and the right RGB camera 206. At this time, the right light 208 illuminates the second downstream-assessment zone Z_{2d}.

Afterwards, the primary AI computer 301 performs the image recognition using the learning model 307 for the captured downstream image.

Thereafter, at step S020, the primary AI computer 301 determines whether the conveyance state of the conveyance object Cob on the collector conveyor BC₁₀₁ satisfies the forwarding condition based on the recognition result of the downstream image.

If the determination result in this the step S020 is positive (see Yes route from step S020), the system computer 303 sends the resume signal to the I/O controller 304. The I/O controller 304 received the resume signal sends the resume request to the conveyor controller CTR_{BC}. The conveyor controller CTR_{BC} received this resume request restarts the collector conveyor BC₁₀₁ in the stationary state (step S025). As a result, the conveyance object Cob on is conveyed further in the downstream direction Ad.

On the other hand, if the determination at step S020 is negative (see No route from step S020), the system computer 303 does not actively control the I/O controller 304 and the conveyor controller CTR_{BC}. That is, in this case, the stationary state of the collector conveyor BC₁₀₁ continues. As a result, the conveyance object Cob on the collector conveyor BC₁₀₁ is kept holding as it is in the second downstream-assessment zone Z_{2d}.

At this time, at step S030, the system computer 303 executes the ‘need-of-care control’. In this need-of-care control, as shown in FIG. 15, the step S045 and the step S050 are executed in parallel.

Specifically, at step S045, the system computer 303 indicates the problems of the conveyance state of the conveyance object Cob on the touch screen 305 (see FIG. 11, for example). This allows an operator to promptly know the problems of the conveyance object Cob held in the second downstream-assessment zone Z_{2d}.

At step S050, the system computer 303 turns on the status indicator 306 via the I/O controller 304. This visually provides a call to an operator's attention even if he/she is a short distance away from the conveyor supervisor 1000. That is, it is possible to notify the operator that the conveyance object Cob held in the second downstream-assessment zone Z_{2d} is requiring some assistance.

Afterwards, at step S035 of FIG. 14, the touch screen 305 waits for an input of the overriding command from an operator. As described above, in order to complete this overriding command input, it is required to input the overriding reason into the touch screen 305. That is, in this the step S035, the operator must enter the overriding reason (see FIG. 13) into the touch screen 305, and touch the ‘Submit’ button on the touch screen 305 to complete the input of the overriding command. Only then is the overriding operation executed (Yes route from step S035).

On the other hand, when the input of the overriding command has not been completed (see No route from step S035), the conveyance object Cob on the collector conveyor BC₁ is held as it is at the second downstream-assessment zone Z_{2d}.

Thereafter, when the input of the overriding command is completed and the overriding operation is executed (see Yes route from step S035), then at step S040, the system computer 303 forwards the overriding reason entered via the touch screen 305 to the primary AI computer 301. The primary AI computer 301 updates the learning model 307 based on the upstream and downstream images of the conveyance object Cob, which was subject to the overriding operation, and the overriding reason received from the system computer 303.

Then, at step S025, the system computer 303 transmits the resume signal to the I/O controller 304. The I/O controller 304 received the resume signal, via the conveyor controller CTR_{BC}, restarts the collector conveyor BC₁₀₁ in the stationary state. As a result, the conveyance object Cob is further carried in the downstream direction Ad.

The present invention is not limited to the above-described embodiment and the variant thereof, and can be variously modified and implemented.

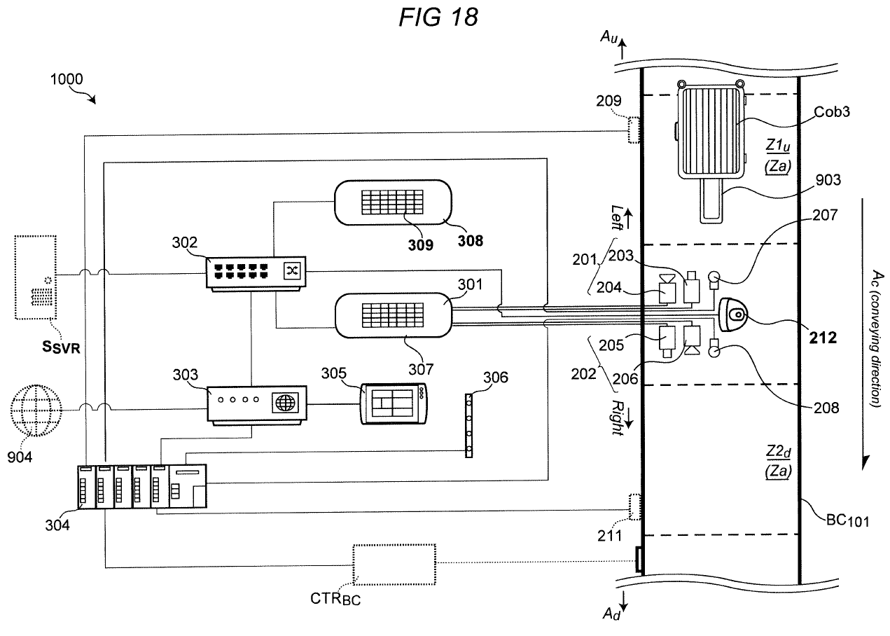

As shown in FIG. 18, a CCTV camera 212 may be added to the conveyor supervisor 1000 described in the above embodiment. For example, the CCTV camera 212 is communicably connected to the network hub 302. The CCTV camera 212 is supplied electric power from the network hub 302 with POE. Although there are no restrictions on the installation position of the CCTV camera 212, it may be preferable to put the CCTV camera 212 at the sensor head 103.

The CCTV images captured by the CCTV camera 212 are recorded and saved to a data storage server S_{SVR} which is communicably connected to the network hub 302 of the conveyor supervisor 1000.

The CCTV images captured by the CCTV camera 212 are processed by a secondary AI computer 308 which is installed in the main body 101 of the conveyor supervisor 1000. The secondary AI computer 308 is a single-board computer that is capable of neural network processing based on image data. The secondary AI computer 308 is communicably connected to the network hub 302.

The secondary AI computer 308 is used to detect a suspicious person (e.g. a person who has intruded into an area near the conveyor supervisor 1000 or on the collector conveyor BC₁₀₁ and a child who has accidentally strayed on the collector conveyor BC₁₀₁) by analysing and recognising people captured in the CCTV image, based on a CCTV learning model 308 stored in the storage device of the secondary AI computer 308 and the CCTV images taken by the CCTV camera 212.

The analysis and recognition results of the CCTV images obtained by the secondary AI computer 308 are stored in the data storage server S_{SVR}.

Accordingly, the recognition result of the CCTV images and the CCTV images stored on the data storage server S_{SVR} can be checked as necessary.

Further, when the secondary AI computer 308 detects a suspicious person based on the CCTV images, the system computer 303 may urgently stop the collector conveyor BC₁₀₁ via the I/O controller 304 and the conveyor control unit CTR_{BC}.

Also, when the secondary AI computer 308 detects a suspicious person, the system computer 303 may send a signal, which is for notifying that the suspicious person has been detected, to other external systems (e.g. a security system of the airport).

The primary AI computer 301 may determine the conveying direction Ac of the collector conveyor BC₁₀₁ based on the upstream image and/or the downstream image. That is, the primary AI computer 301 judges the conveying direction Ac of the collector conveyor BC₁₀₁ is either rightwards (see FIG. 1) or leftwards (see FIG. 16) based on the upstream image and/or the downstream image.

In the above embodiment, if the result of the determination at the step S005 shown in FIG. 14 is positive (see Yes route from step S005 in FIG. 14), the right three-dimensional camera 205 and the right RGB camera 206 does not capture an image (i.e. the downstream image), but it is not limited to this configuration.

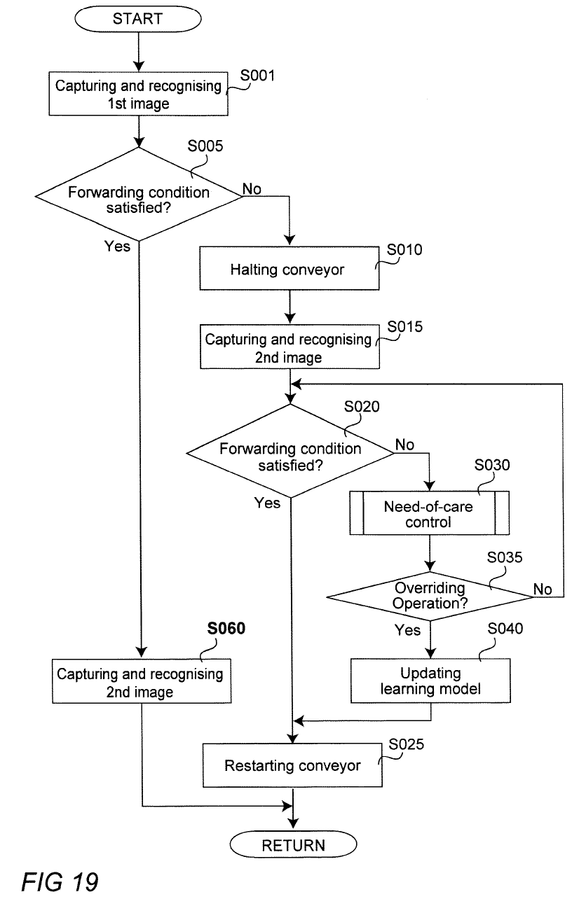

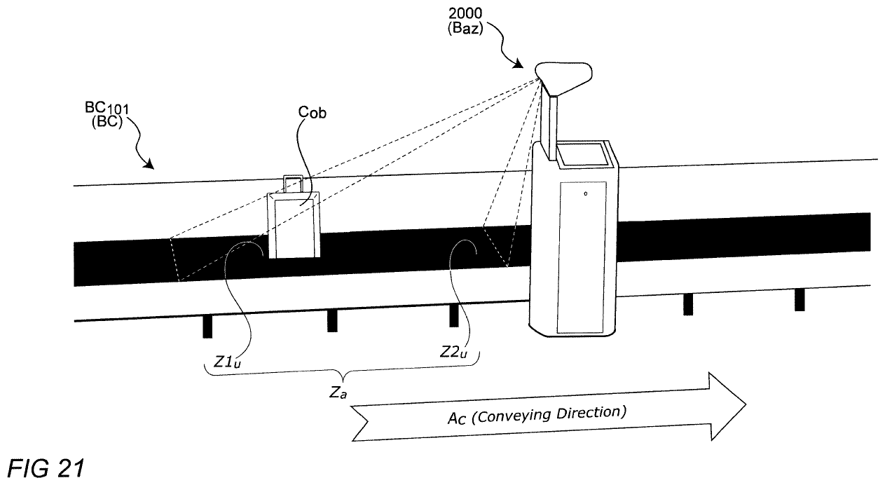

For example, as shown in FIG. 21, even if the primary AI computer 301 determines that a conveyance object Cob on the collector conveyor BC₁₀₁ satisfies the forwarding condition (see Yes route from step S005 in FIG. 19), then the right three-dimensional camera 205 and the right RGB camera 206 may capture an image of the conveyance object Cob as the downstream image.

According to this arrangement, the learning model 307 can be further trained based on a large number of the downstream images.

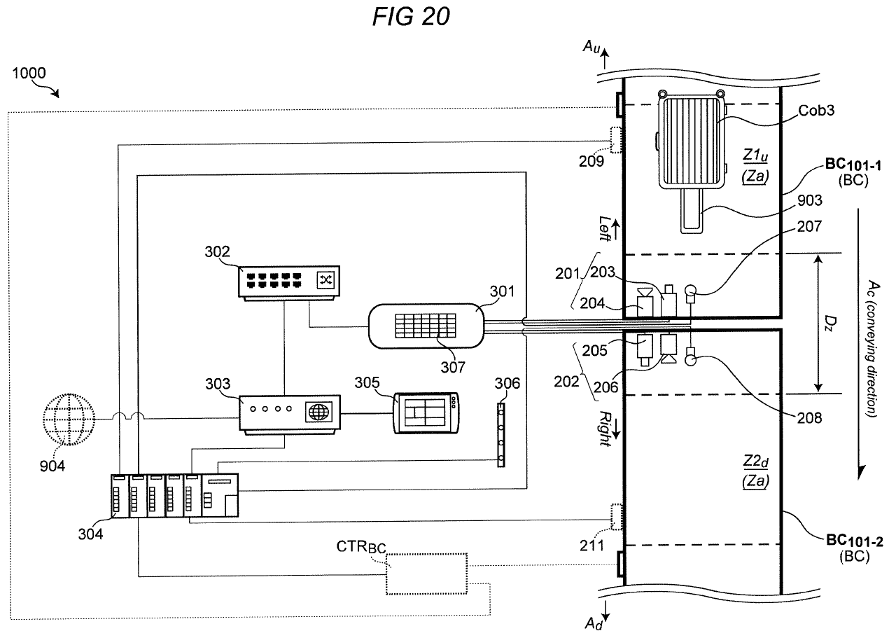

As shown in FIG. 20, even if the collector conveyor has a multiple of conveyors such as a first conveyor BC₁₀₁₋₁ and a second conveyor BC₁₀₁₋₂, the conveyor supervisor 1000 is compatible with these conveyors BC₁₀₁₋₁ and BC₁₀₁₋₂ without problems.

That is, in the configuration as shown in FIG. 20, the first conveyor BC₁₀₁₋₁ can be operated independently of the second conveyor BC₁₀₁₋₂ even while a conveyance object Cob is stopped in the second downstream-side assessment zone Z_{2d} on the second conveyor BC₁₀₁₋₂. In other words, even when the operation of the second conveyor BC₁₀₁₋₂ is suspended, the first collector conveyor BC₁₀₁₋₁ can be operated.

Accordingly, even when the conveyance object Cob is stopped in the second downstream-assessment zone Z_{2d}, it is possible to suppress an impact onto handling process carried out by the automatic baggage handling system Bap.

As described in detail above, according to the conveyor controlling apparatus and method of the present invention, it is possible to assess appropriately whether the conveyance state of various types of conveyance objects meets different forwarding conditions for each automatic conveyance system so that the conveyance objects are precisely controlled in accordance with the assessed conveyance state.

Specifically, according to the conveyor controlling apparatus and method of the present invention, an operator can be swiftly made aware of a conveyance object, which is halted in the second downstream-assessment zone having some problems that does not meet the forwarding condition.

Further, it is also possible to quickly and automatically resume temporarily halted forwarding of the conveyance object in the downstream direction once the problems of the conveyance object are fixed by the operator as the conveyor is automatically restarted when satisfying of the forwarding condition is determined based on the downstream image.

In addition, it is possible to improve the accuracy of determination on the conveyance state by recognising the conveyance state of the conveyance object based on the learning model and the upstream image and/or the downstream image, and determining whether the recognised conveyance state satisfies the forwarding condition.

In addition, it is possible to improve automatically the accuracy of the learning model by simply carrying out the normal handling procedures for the conveyance object.

That is, an operator is simply required to input the reason why the operator needs to execute the overriding operation, but in fact, the learning model is updated based on this reason (i.e. the overriding reason) and the upstream and/or downstream images. Accordingly, the accuracy of the learning model can be automatically improved without requiring educating operators on how to update the learning model.

In addition, it is possible to easily and reliably capture the upstream and downstream images by arranging the upstream capturing device and the downstream capturing device being adjacent to one another and orientated in opposing directions.

Further, it is possible to capture clearly the upstream image and the downstream image of the conveyance object from above by mounting the upstream capturing device and the downstream capturing device in the head unit.

Further, it is possible to capture clearly the upstream image and the downstream image by illuminating the first upstream-assessment zone and the second downstream-assessment zone.

In addition, it is possible to capture easily and clearly the upstream and downstream-side images by providing the upstream and downstream-side lighting devices at the head unit.

In addition, the zone-separation distance is adjustable according to the processing capability related to the assessment of the conveyance state.

For example, if the processing power of the image-analysing module is relatively higher, then the zone-separation distance may beset relatively shorter. On the other hand, if the processing power of the image-analysing module is relatively lower, then the zone-separation distance may be set relatively longer.

Specifically, in the above-described first embodiment, the collector conveyor BC₁₀₁ continues its operation while the primary AI computer 301 determines whether the conveyance state of the conveyance object Cob on the collector conveyor BC₁₀₁ satisfies the forwarding condition based on the learning model 307 and the upstream image (i.e. while the primary determination is carried out). As a result, the conveyance object Cob continues to move in the downstream direction Ad even while the processing of the primary determination is ongoing. However, in this case, the right three-dimensional camera 205 and the right RGB camera 206 could not capture the conveyance object Cob, if a result of the primary determination came out after the conveyance object Cob has passed the second downstream-assessment zone Z_{2d} and further moved in the downstream direction Ad.

For this reason, the zone distance is set taking into account the processing power of the image-analysing module (primary AI computer 301).

In addition, it is possible to seek quickly and reliably a possible assistance from an operator by visually and/or aurally notifying an operator of a result of the determination whether the conveyance state of the conveyance object meets the forwarding condition.

This also allows the operator to do other work until the operator gets a visual and/or aural notification that the forwarding condition has not been satisfied. Accordingly, the work efficiency of the operator may be improved.

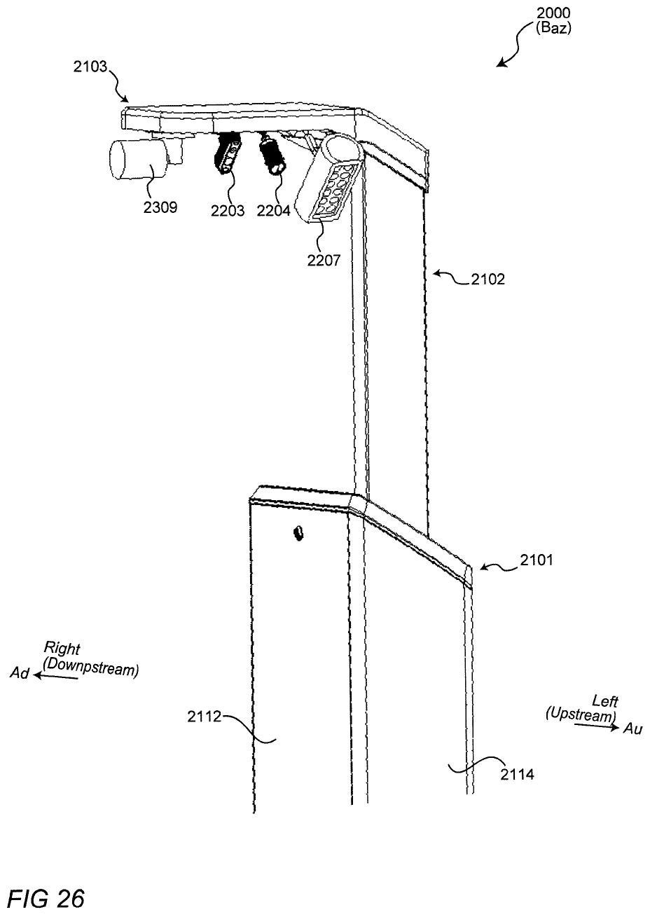

The second embodiment of the present invention will now be described using mainly FIGS. 21 to 34.

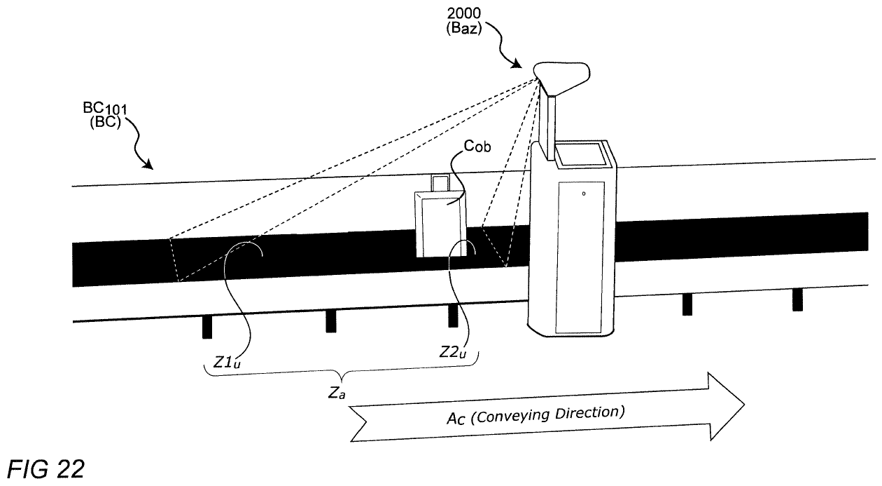

As shown in FIGS. 21 and 22, a conveyor supervisor 2000 (conveyor controlling apparatus Baz), which is installed in the vicinity of a belt conveyor BC, assesses whether a conveyance state of the conveyance object Cob on the belt conveyor BC satisfies a predetermined forwarding condition.

The conveyor supervisor 2000 is designed for an airport AP in the same manner of the conveyor supervisor 1000 according to the first embodiment. The conveyor supervisor 2000 can also be utilised in both the FOH and the BOH of the airport AP. In this airport AP, each of the conveyor supervisors 2000 is installed at the points shown as “Baz1”, “Baz2”, and “Baz3” in FIG. 2, but in the present embodiment, one of the conveyor supervisors 2000 installed in the place shown as “Baz1” in FIG. 2 will be described.

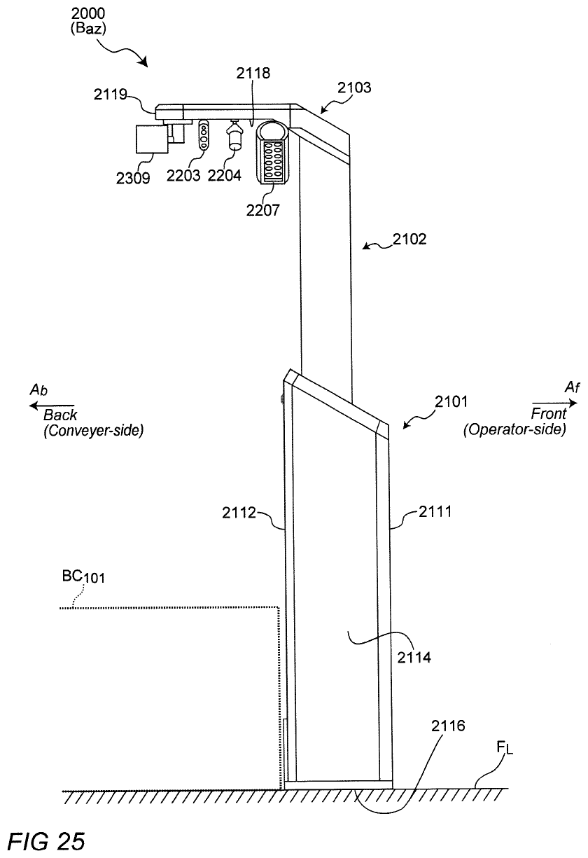

The conveyor supervisor 2000 is installed in a position abutting onto the collector conveyor BC₁₀₁ (see FIG. 25). The conveyor supervisor 2000 assesses whether a conveyance state of the conveyance object Cob carried by the collector conveyor BC₁₀₁ satisfies a forwarding condition which is subjected to the automatic baggage handling system Bap.

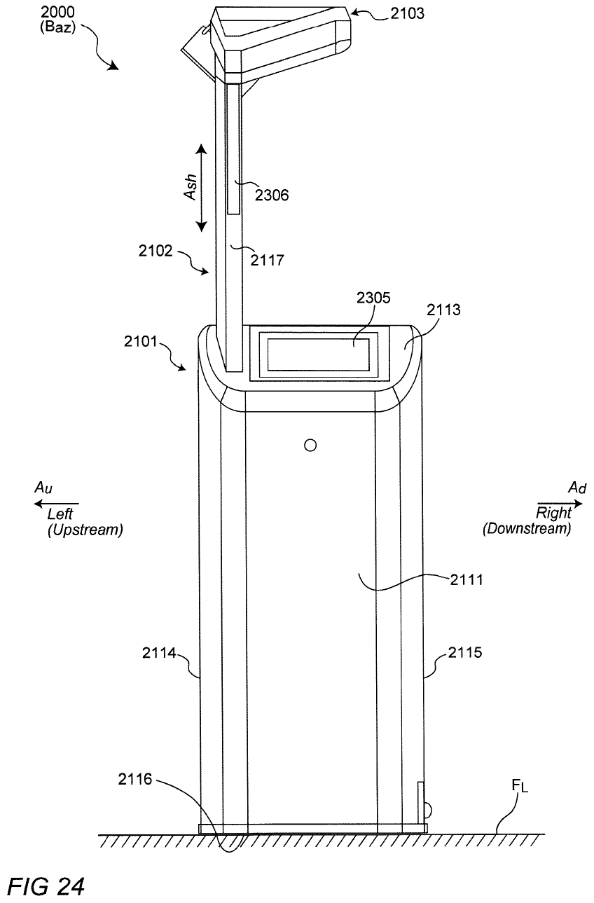

As shown in FIGS. 24 to 26, the conveyor supervisor 2000 comprises a main body 2101, a pillar 2102, and a sensor head (head unit) 2103.

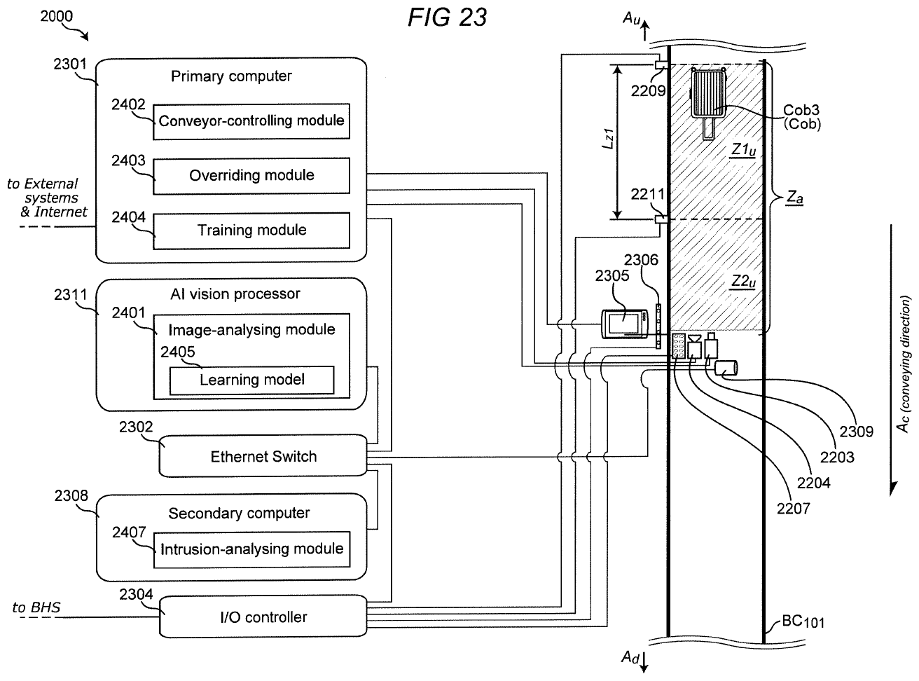

The main body 2101 is a pedestal portion of which a bottom face 2116 is placed on a floor F_{L} and vertically extends upwards. Further, as shown in FIG. 23, a primary computer 2301, an AI vision processor 2311, an Ethernet switch 2302, a secondary computer 2308, and an I/O controller 2304 are included in the main body 2101.

A DC power supply unit is also provided in the main body 2101, but illustration is omitted.

A top face 2113 of the main body 2101 is formed as a plane extending diagonally downward from a back face 2112 to a front face 2111. A touch screen (display unit) 2305 is provided on the top face 2113.

The pillar 2102 is a member extending upward from the main body 2101. A status indicator 2306 is provided on a front face 2117 of the pillar 2102.

Further, the pillar 2102 is slidably fixed to the main body 2101 so that the height of the sensor head 2103 is adjustable as shown by the bi-directional arrow Ash in FIG. 24.

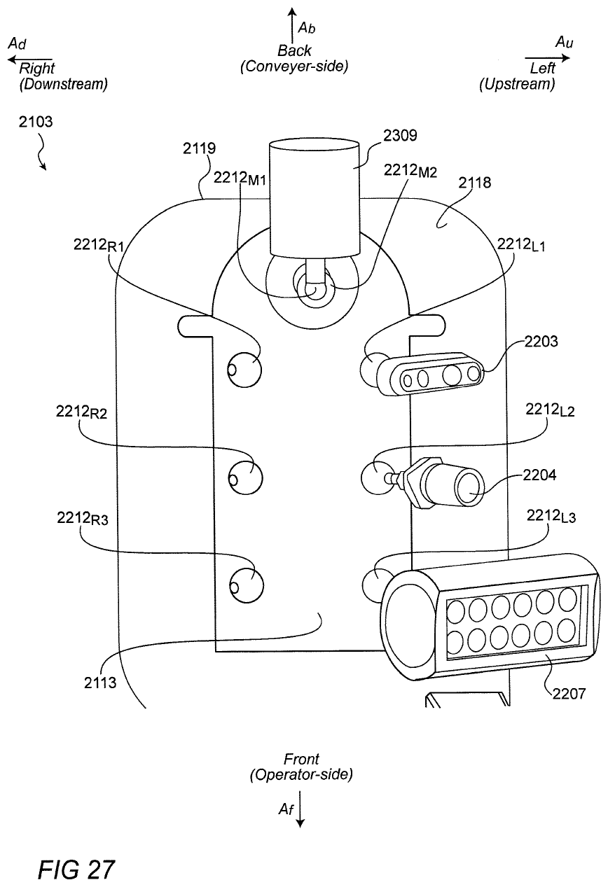

The sensor head 2103 is an assembly unit fixed to the top end of the pillar 2102. As shown in FIG. 27, a base-plate 2113 is fixed to the bottom face 2118 of the sensor head 2103. A left three-dimensional camera (capturing device/upstream capturing device) 2203, a left RGB camera (capturing device/upstream capturing device) 2204, and a left light (upstream lighting device) 2207 are individually and adjustably mounted to the base-plate 2113 of the sensor head 2103 via respective ball joints 2212_{L1}, 2212_{L2}, and 2212_{L3}.

A CCTV camera (intrusion camera) 2309 is a security camera and its frame rate can be adjusted.

The images (intrusion image) captured by the CCTV camera 2309 are transmitted to the secondary computer 2308 via the Ethernet switch 2302 as image stream data.

The CCTV camera 2309 is adjustably mounted to the base-plate 2113 via a ball-joint 2212_{M1} and a swing-shaft 2212_{M2}. In this example shown in FIGS. 25 and 27, the CCTV camera 2309 is directed toward the rear direction Ab of the conveyor supervisor 2000. However, the monitoring-focal direction can be adjusted as needed so that the CCTV camera 2309 selectively monitors the upstream direction Au or the downstream direction Ad.

Further, as shown in FIG. 25, a front edge 2119 of the sensor head 2103 projects further behind the back face 2112 of the main body 2101. Hence, when the conveyor supervisor 2000 is installed in such a manner that the back face 2112 abuts onto the collector conveyor BC₁₀₁, the equipment provided under the bottom face 2118 of the sensor head 2103 is located above the collector conveyor BC₁₀₁.

Each of the left three-dimensional camera 2203 and the left RGB camera 2204 captures an image of the conveyance object Cob as a ‘first image’ when the conveyance object Cob is in an first upstream-assessment zone Z₁ᵤ on the collector conveyor BC₁₀₁ and while the conveyance object Cob is conveyed by the collector conveyor BC₁₀₁ in a direction (see the arrow Ac in FIG. 23) towards the left three-dimensional camera 2203 and the left RGB camera 2204.

In addition, each of the left three-dimensional camera 2203 and the left RGB camera 2204 captures an image of the conveyance object Cob stationary in a second upstream-assessment zone Z₂ᵤ on the collector conveyor BC₁₀₁ as a ‘second image’.

Each of the images captured by the left three-dimensional camera 2203 is transmitted in real time to the primary computer 2301 as data processed three-dimensionally (3D point cloud data) about the conveyance object Cob. Each of the images of the conveyance object Cob captured by the left RGB camera 2204 is transmitted in real time to the primary computer 2301 as raw data that is not subjected to special processing.

In the present embodiment, the conveying direction Ac of the collector conveyor BC₁₀₁ is the right direction (see FIGS. 21 and 22, for example) with respect to the conveyor supervisor 2000. Accordingly, each capturing direction of the left three-dimensional camera 2203 and the left RGB camera 2204 is directed towards an upstream direction (see an arrow Au in FIG. 27).

The left RGB camera 2204 is a Global Shutter RGB type camera with a fixed manual focus lens which is directed to the assessment zone Za including both of the first upstream-assessment zone Z₁ᵤ and the second upstream-assessment zone Z₂ᵤ.

The left RGB camera 2204 is communicably connected to the primary computer 2301 with a USB3 or similar cable.

The image data transmitted from the left RGB camera 2204 is forwarded by the primary computer 2301 to the AI vision processor 2311 for the AI analysis carried out by the AI vision processor 2311.

The AI vision processor 2311 is a computer dedicated for neural net artificial intelligence (AI) processing.

The AI vision processor 2311 has a memory in which an image-analysing module 2401 and a learning model 2405 are stored.

The AI vision processor 2311 receives the data of the images captured by each of the left three-dimensional camera 2203 and the left RGB camera 2204 from the primary computer 2301.

The image-analysing module 2401, which is a software module, implements the learning model 2405 which has been preliminarily trained.

The image-analysing module 2401 assesses and determines whether the conveyance state of the conveyance object Cob satisfies the forwarding condition based on the received image data and the trained learning model 2405.

The learning model 2405 defines an assessment standard. Specifically, the learning model 2405 is a machine learning model generated based on a vast amount of raw data (training data), in which a number of conveyance objects are photographed individually, and a learning data set corresponding to the factors of the conveyance objects.

The AI vision processor 2311 transmits results of the assessment and determination process to the primary computer 2301.

The training module 2404 of the primary computer 2301 updates the learning model 2405, when the overriding operation (described later) is executed, based on the overriding reason entered into the touch screen 2305 and the image corresponding to the conveyance object Cob subjected to the overriding operation.

The training module 2404 restores the states of the learning model 2405 as needed.

For example, backup data of the learning model 2405 may be periodically saved and stored in the storage device of the primary computer 2301. This affords the ability to restore the learning model 2405 based on the backup data of any restore points. This is particularly useful in the event of any ‘incorrect training data’ which has been fed into and has corrupted the learning model 2405.

Alternatively, a factory default version of backup data of the learning model 2405 may be stored in the storage device of the primary computer 2301. According to this arrangement, the learning model 2405 can be restored to the factory default state at any time.

In other words, even if operators repeatedly enter the overriding reason incorrectly, the training module 2404 can correct the learning model 2405 by restoring the training module 2404 as appropriate.

As shown in FIG. 23, the assessment zone Za on the collector conveyor BC₁₀₁ is an area that approximately corresponds to a photographable area of the cameras towards the upstream direction Au (i.e. the left three-dimensional camera 2203 and the left RGB camera 2204 in this embodiment).

The assessment zone Za has the first upstream-assessment zone Z₁ᵤ and the second upstream-assessment zone Z₂ᵤ.

The assessment zone Za is provided in the upstream direction Au (i.e. the left side in the present embodiment) with respect to the sensor head 2103 shown in FIG. 24.

Each of the first upstream-assessment zone Z₁ᵤ and the second upstream-assessment zone Z₂ᵤ is set as a stationary area regardless of running and stopping of the collector conveyor BC₁₀₁.

The first upstream-assessment zone Z₁ᵤ is provided in the upstream direction Au with respect to the second upstream-assessment zone Z₂ᵤ.

The first upstream-assessment zone Z₁ᵤ is an area in which an image of the conveyance object Cob (i.e. object image) is captured as a ‘first image’ by each of the left three-dimensional camera 2203 and the left RGB camera 2204 while the conveyance object Cob is conveyed by the collector conveyor BC₁₀₁.

As schematically shown in FIG. 23, a first photo-eye sensor 2209 is provided beside an upstream edge of the first upstream-assessment zone Z₁ᵤ.

The first photo-eye sensor 2209 is an optical sensor which detects that the conveyance object Cob has entered the first upstream-assessment zone Z₁ᵤ.

The first photo-eye sensor 2209 is connected to the I/O controller 2304 with a digital I/O cable.

Further, the I/O controller 2304 is communicably connected to the primary computer 2301 via the Ethernet switch 2302.

Hence, the primary computer 2301 can immediately detect that the conveyance object Cob enters into the first upstream-assessment zone Z₁ᵤ by the first photo-eye sensor 2209.

The second upstream-assessment zone Z₂ᵤ is provided in the downstream direction Ad with respect to the first upstream-assessment zone Z₁ᵤ.

The second upstream-assessment zone Z₂ᵤ is an area in which the object image is captured as a ‘second image’ by each of the left three-dimensional camera 2203 and the left RGB camera 2204 when the conveyance object Cob is stationary on the collector conveyor BC₁₀₁ since the collector conveyor BC₁₀₁ is stopped by the primary computer 2301.

Further, in this second upstream assessment zone Z₂ᵤ, an operator can attend on the conveyance object Cob stationary on the collector conveyors BC₁₀₁.

A second photo-eye sensor 2211 is provided beside an upstream edge of the second upstream-assessment zone Z₂ᵤ.

The second photo-eye sensor 2211 is an optical sensor detecting that the conveyance object Cob has entered the second upstream-assessment zone Z₂ᵤ.

The second photo-eye sensor 2211 is connected to the I/O controller 2304 with a digital I/O cable.

Further, the I/O controller 2304 is communicably connected to the primary computer 2301 via the Ethernet switch 2302.

Hence, the primary computer 2301 can immediately detect that the conveyance object Cob enters the second upstream-assessment zone Z₂ᵤ by the second photo-eye sensor 2211.

A length of the first upstream-assessment zone Z₁ᵤ (i.e. a first-zone length—see a sign ‘L_{Z1}’ in FIG. 23) can be adjustably set in accordance with a processing power of the primary computer 2301 and the AI vision processor 2311 as well as a running speed of the collector conveyor BC₁₀₁.

The first-zone length L_{Z1} can be adjusted by changing the height of the sensor head 2103, as shown by the arrow Ash in FIG. 24.

In addition, the first-zone length L_{Z1} can be adjusted by individually changing mounting angle of the left three-dimensional camera 2203 and the left RGB camera 2204 with respect to the sensor head 2103.

As an example, if the processing power of the primary computer 2301 and the AI vision processor 2311 is relatively higher, then the first-zone length L_{Z1} may be set relatively shorter with considering the length of the assessment zone Za and the length of the second upstream-assessment zone Z₂ᵤ. On the other hand, if the processing power of the primary computer 2301 and the AI vision processor 2311 is relatively lower, then the first-zone length L_{Z1} may be set relatively longer with considering the length of the assessment zone Za and the length of the second upstream-assessment zone Z₂ᵤ.

As another example, if the running speed of the collector conveyor BC₁₀₁ is relatively slower, then the first-zone length L_{Z1} may be set relatively shorter. On the other hand, if the running speed of the collector conveyor BC₁₀₁ is relatively faster, then the first-zone length L_{Z1} may be set relatively longer.

As shown in FIG. 27, the left light 2207 is a LED lighting unit that illuminates the first upstream-assessment zone Z₁ᵤ and the second upstream-assessment zone Z₂ᵤ so that the left three-dimensional camera 2203 and the left RGB camera 2204 can clearly capture the first and second images of the conveyance object Cob.

As shown in FIG. 23, the primary computer 2301 is a main computer of the conveyor supervisor 2000.

The primary computer 2301 is connected to the Ethernet switch 2302 with an Ethernet cable.

Hence, the primary computer 2301 is communicably connected to the I/O controller 2304 via the Ethernet switch 2302.

The primary computer 2301 is connected to each of the left three-dimensional camera 2203 and the left RGB camera 2204 with a USB3 or similar cable.

The primary computer 2301 is connected to the touch screen 2305 with a HDMI cable.

The primary computer 2301 is communicably connected to the Internet as well as other external systems.

The primary computer 2301 has a storage device in which software modules such as a conveyer-controlling module 2402, an overriding module 2403 and a training module 2404 are stored.

The conveyer-controlling module 2402 stops the collector conveyor BC₁₀₁ via a conveyor controller (not shown in FIGs) of the automatic baggage handling system Bap such that the conveyance object Cob is positioned stationary within the second upstream-assessment zone Z₂ᵤ if the image-analysing module 2401 of the AI vision processor 2311 determines based on the first image that the conveyance state of the conveyance object Cob does not satisfy the forwarding condition.

Further, via the conveyor controller of the automatic baggage handling system Bap, the conveyer-controlling module 2402 restarts the collector conveyor BC₁₀₁, which is stopped by the conveyer-controlling module 2402, if the image-analysing module 2401 determines based on the second image that the conveyance state of the conveyance object Cob satisfies the forwarding condition.

In the meantime, the determination on the conveyance state of the conveyance object Cob in the first upstream-assessment zone Z₁ᵤ is referred to as the ‘primary determination’. On the other hand, the determination on the conveyance state of the conveyance object Cob in the second upstream-assessment zone Z₂ᵤ is referred to as the ‘secondary determination’.

The overriding module 2403 executes an ‘overriding control’ that forcibly restarts the collector conveyor BC₁₀₁ from the stationary state via the conveyor controller of the automatic baggage handling system Bap. This overriding operation is an operation that is run when an input of the overriding command to the touch screen 2305 is completed.

That is, when the input of the overriding command to the touch screen 2305 is completed, the overriding module 2403 executes the overriding control.

In other words, this overriding operation is carried out in a situation where the image-analysing module 2401 of the AI vision processor 2311 determined that the conveyance state of the conveyance object Cob did not satisfy the forwarding condition, but an operator completed inputting the overriding command into the touch screen 2305.

As shown in FIG. 12, each of the check boxes for corresponding to the problems of the conveyance state of the conveyance object Cob is indicated on the touch screen 2305. Accordingly, an operator, who saw the indication on the touch screen 2305, checks an actual state of the conveyance object Cob, which is temporarily stopped in the second upstream-assessment zone Z₂ᵤ, and inputs the at least one or more overriding reasons into the touch screen 2305 by entering a tick or ticks into the corresponding checkbox or checkboxes.

For example, assuming that the image-analysing module 2401 of the AI vision processor 2311 recognises that the size of a conveyance object Cob exceeds the predetermined specified size (height, width and depth), as a result, the image-analysing module 2401 determines that the conveyance state of this conveyance object Cob does not satisfy the forwarding condition, but the operator has confirmed that the size of this conveyance object Cob stopped is actually within the predetermined specified dimensions.

In this case, the operator enters a tick into the check box of ‘Acceptable size’, which is one of the overriding reasons displayed on the touch screen 2305 as shown in FIG. 13, and then touches a “Submit” button indicated on the touch screen 2305, otherwise the overriding operation will not be executed. In other words, it is mandatory to include the overriding reason to complete inputting the overriding command.

The training module 2404 updates the learning model learning model 2405, in response to an overriding command containing an overriding reason entered by an operator via the touch screen 2305 based on the entered overriding reason and the first image and/or the second image.

The training module 2404 sequentially records the results of the primary and secondary determinations by the conveyor control unit 2402 and the first and second images corresponding to these determinations into a storage server (not shown in FIGs). This storage server is an external server that is communicably connected to the conveyor supervisor 2000.

The ‘conveyance state’ includes various factors with regard to the conveyance object Cob (e.g. dimensions, orientation, type, condition of accessories, presence or absence of overlapping, distance from other conveyance objects Cob, presence or absence of transport tub, open/close state, presence or absence of baggage tag, and so on).

For example, when a conveyance object Cob is conveyed by the collector conveyor BC₁₀₁, the image-analysing module 2401 of the AI vision processor 2311, based on the learning model 2405 and the first image and/or the second image, recognises the type of the conveyance object Cob as a suitcase (hard bags), a duffel bag (soft bags), a backpack (soft bags), a sports bag (soft bags), or others.

In addition, when a conveyance object Cob has wheels (movable parts), the image-analysing module 2401 of the AI vision processor 2311 recognises whether the conveying direction Ac of the collector conveyor BC₁₀₁ and a projecting direction of the wheels protrude from the conveyance object Cob is substantially the same. Further, the image-analysing module 2401 recognises whether the orientation of the conveyance object Cob is either upright or lying. As shown in FIG. 9, wheels 901 of a suitcase Cob1 protrudes towards in a direction that is the same as the conveying direction Ac of the collector conveyor BC₁₀₁.

Further, the image-analysing module 2401 of the AI vision processor 2311 recognises whether an auxiliary piece such as a handle (movable parts) of a conveyance object Cob is appropriately stowed in the conveyance object Cob. In this regard, FIG. 9 shows a handle 902 of a suitcase Cob2 is extended and not properly stowed away into the suitcase Cob2, and orientation of the suitcase Cob2 is upright.

In addition, FIG. 9 shows a suitcase Cob3 that is lying on the collector conveyor BC₁₀₁ (i.e. the orientation of the suitcase Cob3 is proper), but a handle 903 of the suitcase Cob3 is extended and not properly stowed away into the suitcase Cob3.

The image-analysing module 2401 also recognises whether one conveyance object Cob overlaps another conveyance object Cob (see suitcases Cob4 and Cob5 in FIG. 9).

In addition, the image-analysing module 2401 recognises whether a distance (see the arrow D1 in FIG. 9) between one conveyance object Cob5 and another conveyance object Cob6 is shorter than a threshold distance.

If a baggage tag is affixed to a conveyance object Cob, the image-analysing module 2401 may recognise the affixed baggage tag.

If there is relatively large damage to a conveyance object Cob, the image-analysing module 2401 may recognise the damage on the conveyance object Cob.

Further, the image-analysing module 2401 recognises whether a conveyance object Cob is placed in a transport tub.

The image-analysing module 2401 also recognises whether a shoulder strap is properly bundled/stowed if a conveyance object Cob has the shoulder strap.

The image-analysing module 2401 may recognise whether a conveyance object Cob is properly closed (i.e. the open/close state of the conveyance object Cob).

That is, for example, the image-analysing module 2401 of the AI vision processor 2311 assesses that a conveyance state of a conveyance object Cob does not satisfy the forwarding condition (i.e. the conveyance state corresponds at least one of the rejection categories), if the image-analysing module 2401 recognises at least one of:
(i) the size of a conveyance object Cob exceeds the prescribed size (height, width and depth);
(ii) the orientation of a conveyance object Cob is upright;
(iii) the conveying direction Ac of the collector conveyor BC₁₀₁ and the projecting direction of wheels of a conveyance object Cob are substantially the same;
(iv) a handle is not appropriately stored in a conveyance object Cob;
(v) there is no baggage tag affixed to a conveyance object Cob;
(vi) a conveyance object Cob is recognised as a soft bag that is not placed in a transport tub;
(vii) a shoulder strap of a conveyance object Cob is not properly bundled/stowed;
(viii) a conveyance object Cob is not properly closed;
(ix) there are extraneous items (i.e. passports, books, magazines, documents and so on) left on a conveyance object Cob; and
(x) a conveyance object Cob on the collector conveyor BC₁₀₁ is an ‘unknown object’.

The conveyer-controlling module 2402 of the primary computer 2301 displays the processing status by the image-analysing module 2401 of the AI vision processor 2311 on the touch screen 2305. For instance, FIG. 10 shows an indication on the touch screen 2305 while the image analysis process by the image-analysing module 2401 is ongoing.

When the forwarding condition is not met by the conveyance state of the conveyance object Cob, then the conveyer-controlling module 2402 of the primary computer 2301 displays the problems of the conveyance state on the touch screen 2305. For example, an indication on the touch screen 2305 is shown in FIG. 11 when the image-analysing module 2401 of the AI vision processor 2311 recognises: wheels of the conveyance object Cob projects to the conveying direction Ac; the conveyance object Cob requires a transport tub; and orientation of the conveyance object Cob is upright.

As shown in FIG. 24, the touch screen 2305 is an interface device provided on the top face 2113 of the main body 2101. The touch screen 2305 is communicably connected to the primary computer 2301 by the HDMI cable.

The touch screen 2305 visually notifies various information to an operator in accordance with the commands from the touch screen 2305. Further, the touch screen 2305 receives inputs from the operator and forward the inputs entered by the operator to the touch screen 2305.

The primary computer 2301 ascertains the conveying direction Ac of the collector conveyor BC₁₀₁ based on the installation information entered by an operator through the touch screen 2305. Alternatively, the primary computer 2301 may determine that the conveying direction Ac of the collector conveyor BC₁₀₁ is either rightwards or leftwards based on the first image and/or the second image.

As shown in FIG. 23, the Ethernet switch 2302 is a network switch that supports the TCP/IP protocol having power-over-Ethernet (POE) function. The Ethernet switch 2302 is communicably connected to each of the primary computer 2301, the AI vision processor 2311, the secondary computer 2308, and the CCTV camera 2309 with an Ethernet cable.

The status indicator 2306 is an LED light unit that illuminates red, green, or amber for easy identification of the operational state of the conveyor supervisor 2000.

Specifically, the conveyer-controlling module 2402 of the primary computer 2301 controls the status indicator 2306 via the I/O controller 2304 in accordance with the working state of the conveyor supervisor 2000 as summarised below.

| Working State | LED Illumination |
|---|---|
| System Unhealthy | Amber/Red Steady |
| Powered Off | Off |
| System Healthy | Green |
| Non-compliant baggage detected | Amber Flashing |
| Intrusion detected | Red Flashing |

According to this, it is possible to visually notify operators of the conveyance state of the conveyance object Cob.

The I/O controller 2304 is a control unit that is communicably connected with a digital I/O cable to each of the first photo-eye sensor 2209, the second photo-eye sensor 2211, the status indicator 2306, the left light 2207, and a conveyor controller (not shown in FIGs) of the automatic baggage handling system Bap.

The I/O controller 2304 is also connected to the Ethernet switch 2302 with an Ethernet cable. Hence, the primary computer 2301 controls the collector conveyor BC₁₀₁ via the I/O controller 2304.

The secondary computer 2308 is a supplementary computer that controls the processing related to an ‘intrusion control’ among the processes of the conveyor supervisor 2000.

The secondary computer 2308 is connected to the Ethernet switch 2302 with an Ethernet cable.

The secondary computer 2308 has a storage device in which software modules such as an intrusion-analysing module 2407 are stored.

The intrusion-analysing module 2407 implements an intrusion learning model (not shown in FIGs) which has been preliminarily trained for the intrusion control.

The secondary computer 2308 continuously receives image stream data fed from the CCTV camera 2309 via the Ethernet switch 2302.

The secondary computer 2308 runs dedicated human detection application algorithms implemented in the intrusion-analysing module 2407.

The intrusion-analysing module 2407 is designed for detecting the presence of humans in a region of interest which corresponds to a ‘keep-out zone’. The region of interest is calibrated to the collector conveyor BC₁₀₁ in view of the image stream captured by the CCTV camera 2309.

The keep-out zone is an area extending along the collector conveyor BC₁₀₁ and including at least the collector conveyor BC₁₀₁.

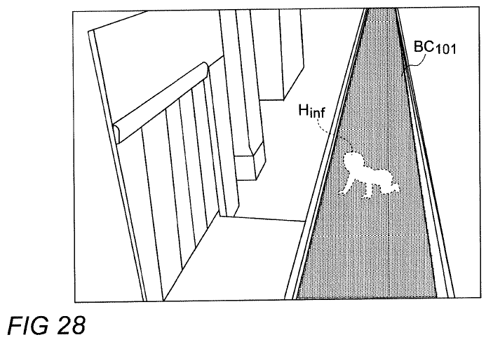

For example, as shown in FIG. 28, an infant H_{inf} may accidentally enter a restricted area in which the collector conveyor BC₁₀₁ is installed.

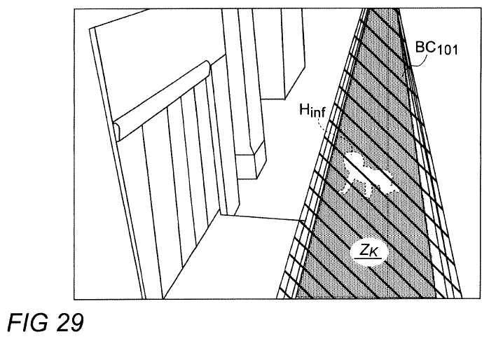

In this case, the intrusion-analysing module 2407 of the secondary computer 2308 detects a presence of the infant Hi within the keep-out zone Z_{K} as shown as shown in FIG. 29.

In response to the detection of the infant H_{inf}, the intrusion-analysing module 2407 of the secondary computer 2308 immediately stops the collector conveyor BC₁₀₁ via the conveyer-controlling module 2402 of the primary computer 2301.

With the above-mentioned arrangement, the conveyor controlling apparatus according to the second embodiment of the present invention provides the following advantages.

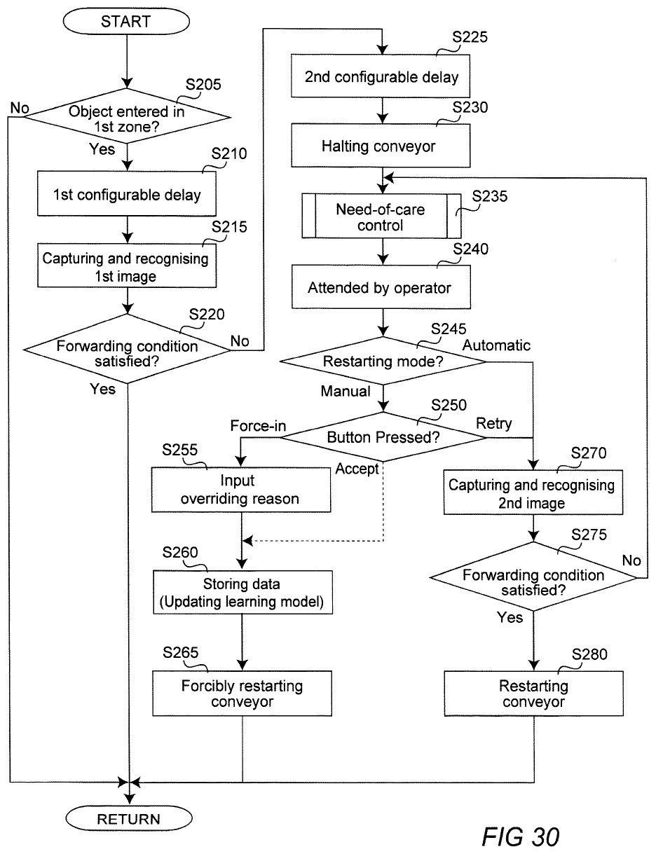

The analysis control of the conveyance object Cob by the conveyor supervisor 2000 is mainly performed in accordance with a main flowchart shown in FIG. 30.

Note that, in parallel with the analysis control of the conveyance object Cob shown in FIG. 201, the intrusion control shown in FIG. 207 is also executed, which will be described later.

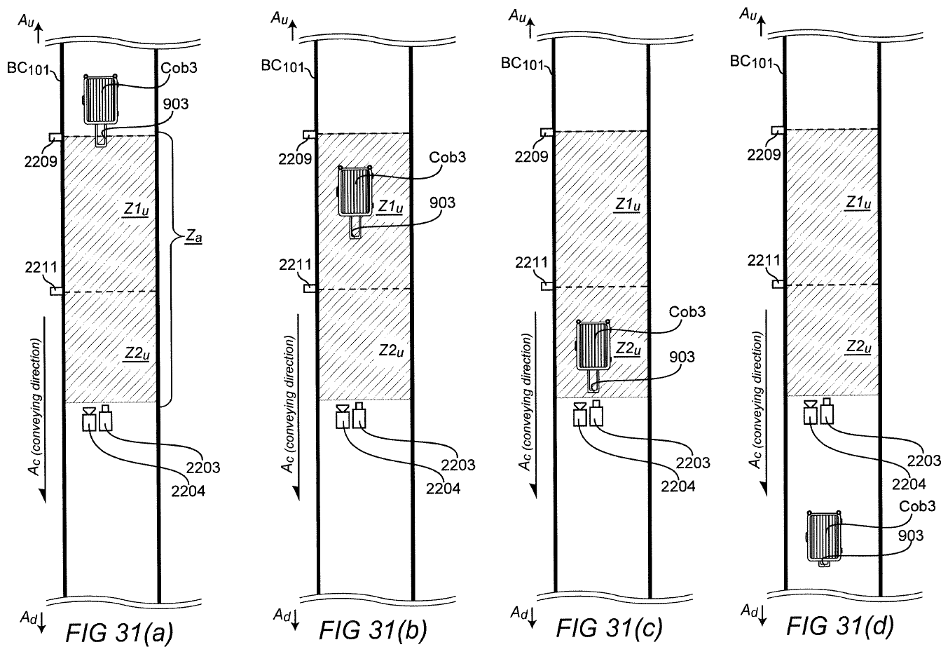

As shown in FIG. 31(a), the conveyer-controlling module 2402 recognises that the conveyance object (suitcase) Cob3 has just entered the first upstream-assessment zone Z₁ᵤ in response to detection by the first photo-eye sensor 2209 that the conveyance object Cob3 which is conveyed from the upstream direction Au to the downstream direction Ad by the collector conveyor BC₁₀₁ (Yes route from step S205 in FIG. 30).

Immediately subsequent to this, the conveyer-controlling module 2402 stays on standby to make a very short delay for ensuring that the entire conveyance object Cob enters the first upstream-assessment zone Z₁ᵤ (step S210).

At this time, the conveyer-controlling module 2402 of the primary computer 2301 obtains the first image of the conveyance object Cob3 captured by each of the left three-dimensional camera 2203 and the left RGB camera 2204 (step 215). During this time, the collector conveyor BC₁₀₁ is still running, hence, the conveyance object Cob3 keeps travelling in the downstream direction Ad.

Then, the image-analysing module 2401 of the AI vision processor 2311 determines whether the conveyance state of the conveyance object Cob3 satisfies the forwarding condition based on the first image captured by each of the left three-dimensional camera 2203 and the left RGB camera 2204 (steps S215 and S220 in FIG. 30).

Also, at this time, the training module 2404 records the analysis results of the conveyance object Cob3 carried out by the image-analysing module 2401 of the AI vision processor 2311 and the captured first image of the conveyance object Cob3 in the external storage server (steps S215 and S220 in FIG. 30).

If the conveyance state of the conveyance object Cob3 satisfies the forwarding condition (Yes route from step S220 in FIG. 30), the conveyer-controlling module 2402 does not take action on the automatic baggage handling system Bap. Hence, the collector conveyor BC₁₀₁ continues running and the conveyance object Cob3 is conveyed to the downstream direction Ad.

On the other hand, if the conveyance state of the conveyance object Cob3 does not satisfy the forwarding condition (No route from step S220 in FIG. 30), the conveyer-controlling module 2402 stops the collector conveyor BC₁₀₁ via the conveyor controller of the automatic baggage handling system Bap so that the conveyance object Cob3 is stationary within the second upstream-assessment zone Z₂ᵤ (step S230 of FIG. 30—see also FIG. 31(c)).

The conveyer-controlling module 2402 recognises that the conveyance object Cob3 has entered the second upstream-assessment zone Z₂ᵤ in response to the second photo-eye sensor 2211 detecting the conveyance object Cob3.

Nevertheless, the conveyer-controlling module 2402 is set to make a very short delay to ensure that the entire conveyance object Cob3 enters the second upstream-assessment zone Z₂ᵤ (step S225 in FIG. 30), then stops the collector conveyor BC₁₀₁ (step S230).

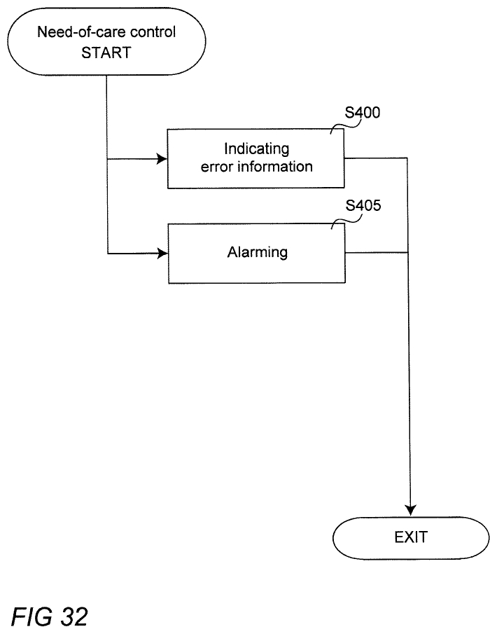

After that, at step S235 of FIG. 30, the conveyer-controlling module 2402 executes a ‘need-of-care control’. In this need-of-care control, as shown in FIG. 32, the steps S400 and S405 are executed in parallel.

At step S400, the conveyer-controlling module 2402 indicates on the touch screen 2305 the determined problems with respect to the conveyance state of the conveyance object Cob3 (see FIG. 11, for example). This control can quickly and specifically notify an operator that there is some problem with the conveyance object Cob3 that is stopped in the second upstream-assessment zone Z₂ᵤ.

Further, at the step S405 shown in FIG. 32, the conveyer-controlling module 2402 illuminates the status indicator 2306 via the I/O controller 2304 in the colour and pattern that correspond to the working state of the conveyor supervisor 2000.

According to this arrangement, even if an operator is a short distance from the conveyor supervisor 2000, the operator can be visually alerted. In other words, it is possible to swiftly notify the operator that some assistance is required for the conveyance object Cob3 stopped in the second upstream-assessment zone Z₂ᵤ.

As a result, the problems of the conveyance object Cob3 are solved (step S240 in FIG. 30).

At this time, if the operation mode of the conveyor supervisor 2000 with regard to restarting the collector conveyor BC₁₀₁ is ‘automatic’ (Automatic route from step S245), the conveyer-controlling module 2402 obtains the second image of the conveyance object Cob3 captured by each of the left three-dimensional camera 2203 and the left RGB camera 2204 (step S270 in FIG. 30).

Further, the image-analysing module 2401 of the AI vision processor 2311 determines whether the conveyance object Cob3 satisfies the forwarding condition based on the second image captured by the left three-dimensional camera 2203 and the left RGB camera 2204 (steps S270 and S275 in FIG. 30).

Also, at this time, the training module 2404 records the analysis results of the conveyance object Cob3 carried out by the image-analysing module 2401 of the AI vision processor 2311, the determination results as to whether or not the conveyance state of the conveyance object Cob3 satisfies the forwarding condition, and the captured second image of the conveyance object Cob3 in the external storage server (steps S270 and S275 of FIG. 30).

If the conveyance state of the conveyance object Cob3 satisfies the forwarding condition (Yes route from S275), the conveyer-controlling module 2402 restarts the collector conveyor BC₁₀₁ via the conveyor controller of the automatic baggage handling system Bap (step S280). At this time, in the example shown in FIG. 31(d), the handle 903 is now retracted into the conveyance object (suitcase) Cob3 and is being conveyed to the downstream direction Ad.

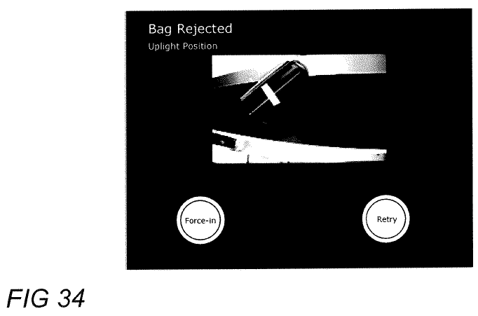

On the other hand, if the operation mode of the conveyor supervisor 2000 with regard to restarting the collector conveyor BC₁₀₁ is ‘manual’ (Manual route from step S245), the conveyer-controlling module 2402 indicates a ‘Force-in’ button and a ‘Retry’ button on the touch screen 2305. FIG. 34 shows an example of the display on the touch screen 2305 at this time.

If the Force-in button is touched by an operator (see Force-in route from step S250 in FIG. 30), the overriding module 2403 indicates on the touch screen 2305 check boxes corresponding to the found problems with respect to the conveyance object Cob3 (see FIG. 12).

In other words, this situation could be, for example, that although an operator has checked the conveyance object Cob3 at step S240, no problem was actually found, and therefore the operator believes that the conveyance object Cob3 should continue travelling in the downstream direction Ad.

At this time, the operator appropriately checks the check boxes corresponding to the reasons why there is no problem with the conveyance object Cob3 (i.e. ‘overriding reason’), then the operator touches a ‘Submit’ button indicated on the touch screen 2305 (step S255).

Also, at this time, the training module 2404 records the analysis results of the conveyance object Cob3 carried out by the image-analysing module 2401 of the AI vision processor 2311, the determination results as to whether or not the conveyance state of the conveyance object Cob3 satisfies the forwarding condition, the captured first image of the conveyance object Cob3, and the overriding reason entered through the touch screen 2305 in the external storage server (step S260).

In addition, the training module 2404 may apply a learning control to the learning model 2405 based on the entered overriding reason.

In short, in a situation where the image-analysing module 2401 of the AI vision processor 2311 has determined that the conveyance state of the conveyance object Cob3 does not satisfy the forwarding condition, but an operator has completed inputting the overriding command through the touch screen 2305, therefore, the overriding module 2403 executes the overriding control to forcibly restart the collector conveyor BC₁₀₁ via the conveyor controller of the automatic baggage handling system Bap (step S265 of FIG. 30).

In contrast, at the step S250, if an operator touches the Retry button (see Retry route from step S250), the conveyer-controlling module 2402 obtains the second image of the conveyance object Cob3 captured by each of the left three-dimensional camera 2203 and the left RGB camera 2204.

In other words, this situation could be, for example, that although an operator has checked the conveyance object Cob3 at the step S240, no problem was actually found, and therefore the operator wants to have the conveyor supervisor 2000 reconfirm the conveyance state of the conveyance object Cob, as a precaution.

As another example situation, an operator has solved the problems of the conveyance object Cob3 at the step S240, and as a precaution, the operator wants to make sure that the correction to the conveyance object Cob3 was appropriate by using the conveyor supervisor 2000.

If the Retry button is touched (see Retry route from step S250), the image-analysing module 2401 of the AI vision processor 2311 determines, based on the second image captured by each of the left three-dimensional camera 2203 and the left RGB camera 2204, whether or not the conveyance state of the conveyance object Cob3 satisfies the forwarding condition (steps S270 and S275).

If the conveyance state of the conveyance object Cob3 satisfies the forwarding condition (Yes route from S275), the conveyer-controlling module 2402 restarts the collector conveyor BC₁₀₁ via the conveyor controller of the automatic baggage handling system Bap (step S280).

Note that an ‘Accept’ button may also be indicated on the touch screen 2305 at the step S250. In this configuration, if the Accept button is touched by an operator, the collector conveyor BC₁₀₁ is forcibly restarted bypassing the step S255 and reaching the step S265. Nevertheless, executing this control shown as the Accept route from the step S250 is normally prohibited because the conveyance object Cob3 is resultantly conveyed in the downstream direction Ad without an operator inputting the overriding command.

‘Intrusion control’ based on an ‘intrusion image’ captured by the CCTV camera 2309 will be described.

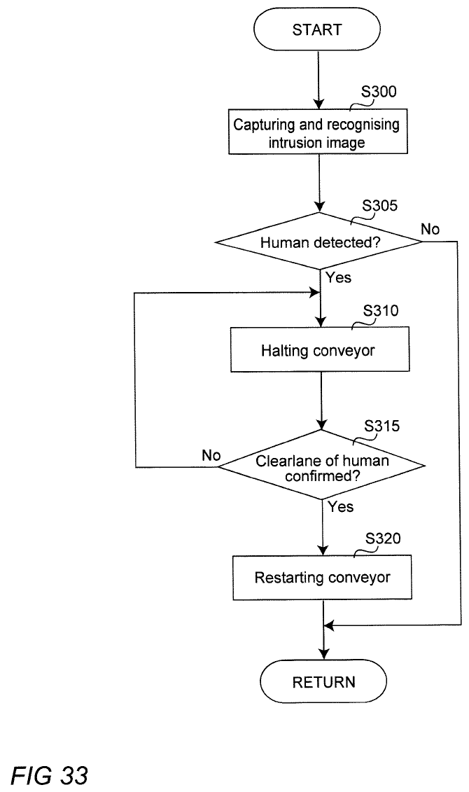

In this intrusion control, the intrusion-analysing module 2407 of the secondary computer 2308 substantively always analyses the image stream (intrusion image) continuously supplied from the CCTV camera 2309 via the Ethernet switch 2302 (step S300 of FIG. 33).

If the intrusion-analysing module 2407 detects the presence of a human within the region of interest (i.e. the ‘keep-out zone Z_{K}’) within the view of the image stream captured by the CCTV camera 2309, the intrusion-analysing module 2407 immediately stops the collector conveyor BC₁₀₁ via the conveyer-controlling module 2402 of the primary computer 2301 (step S310).

After that, if an operator confirms that there is no human in the keep-out zone Z_{K} (Yes route from step S315), the intrusion-analysing module 2407 restarts operation of the collector conveyor BC₁₀₁ via the conveyer-controlling module 2402 of the primary computer 2301.

In the example shown in FIG. 33, the collector conveyor BC₁₀₁ is not restarted unless an operator inputs to the touch screen 2305 that there is no person in the keep-out zone Z_{K} (step S310 via No route from step S315), but it is not limited to this scenario.

For example, if a human presence is detected in the region of interest within the view of the image stream captured by the CCTV camera 2309, but subsequently no human presence is detected in the region of interest, then the intrusion-analysing module 2407 may automatically restart operation of the collector conveyor BC₁₀₁ via the conveyer-controlling module 2402 of the primary computer 2301.

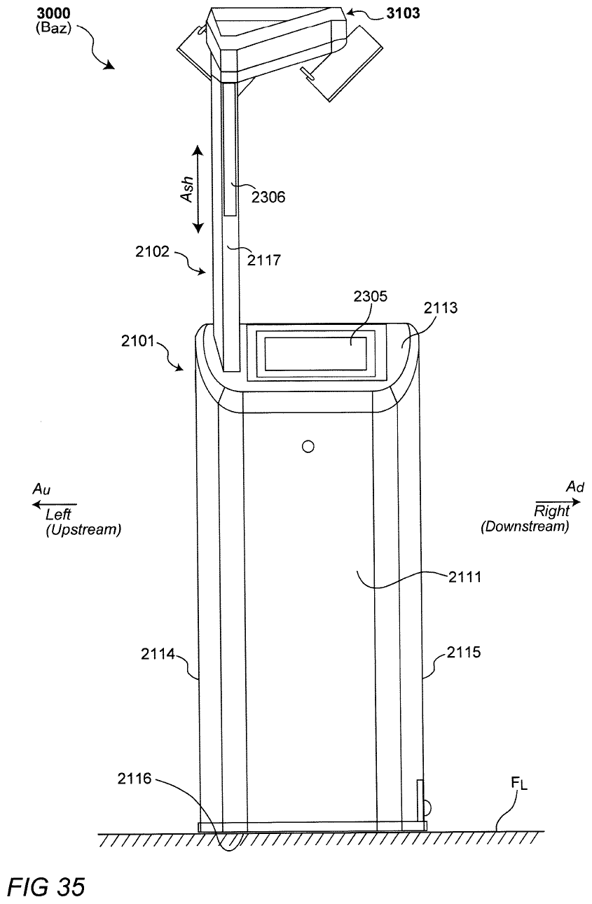

The third embodiment of the present invention will now be described below mainly using FIGS. 35 to 39.

A conveyor supervisor 3000 according to the third embodiment has substantially the same configuration as the conveyor supervisor 2000 according to the second embodiment. Accordingly, differences between the conveyor supervisors 2000 and 3000 will be mainly described here and redundant description will be omitted.

As shown in FIG. 35, a sensor head 3103 of the conveyor supervisor 3000 differs from the sensor head 2103 of the conveyor supervisor 2000 in terms of hardware.

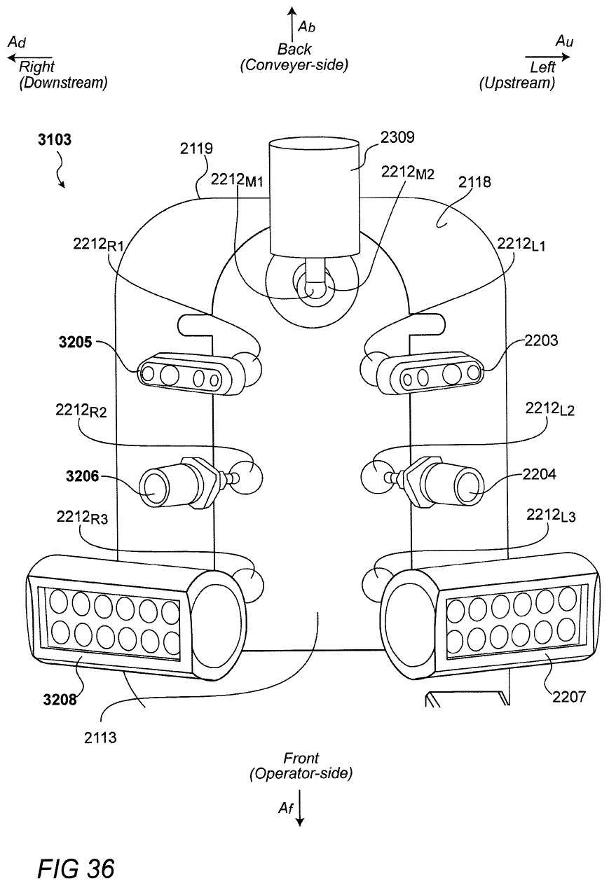

Specifically, as shown in FIG. 36, the sensor head 3103 includes all of the equipment mounted to the sensor head 2103, plus a right three-dimensional camera 3205, a right RGB camera 3206, and right light 3208.

The right RGB camera 3206 is also a Global Shutter RGB type camera with a fixed manual focus lens

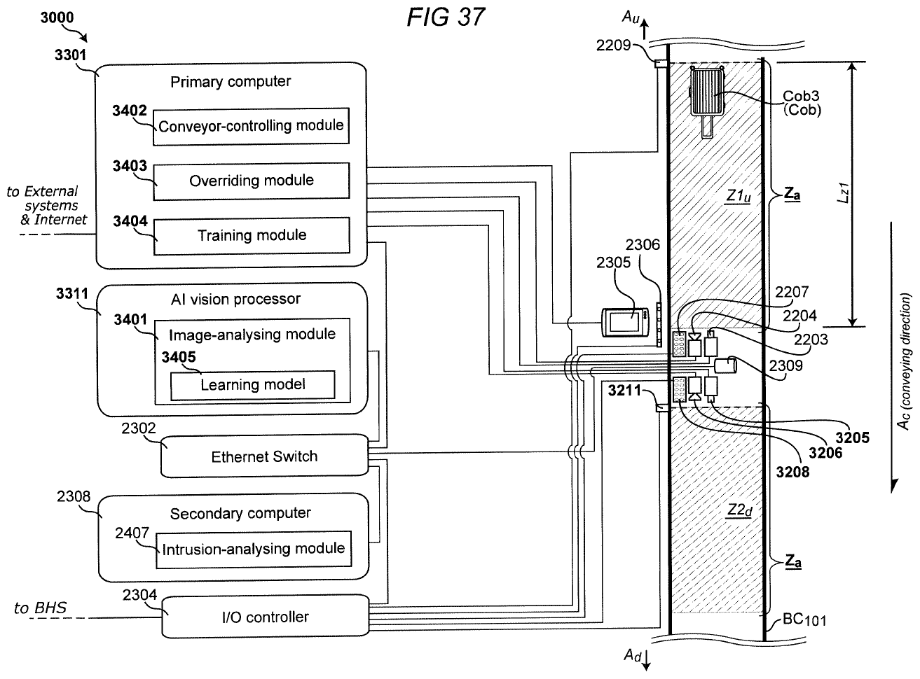

Due to such a hardware difference, in this embodiment, as shown in FIG. 37, the assessment zone Za is divided into the upstream side and the downstream side with respect to the conveyor supervisor 3000.

The first upstream-assessment zone Z₁ᵤ is an area in which an image of the conveyance object Cob (i.e. object image) is captured as the ‘first image’ by each of the left three-dimensional camera 2203 and the left RGB camera 2204 while the conveyance object Cob is conveyed by the collector conveyor BC₁₀₁.

The second downstream-assessment zone Z_{2d} is provided in the downstream direction Ad with respect to the first upstream-assessment zone Z₁ᵤ as well as the conveyor supervisor 3000.

The second downstream-assessment zone Z_{2d} is an area in which the object image is captured as the ‘second image’ by each of the right three-dimensional camera 3205 and the right RGB camera 3206 when the conveyance object Cob is stationary on the collector conveyor BC101 since the collector conveyor BC₁₀₁ is stopped by the primary computer 2301.

The left light 2207 is a LED lighting unit that illuminates the first upstream-assessment zone Z₁ᵤ so that the left three-dimensional camera 2203 and the left RGB camera 2204 can clearly capture the first image of the conveyance object Cob.

The right light 3208 is another LED lighting unit that illuminates the second downstream-assessment zone Z_{2d} so that the right three-dimensional camera 3205 and the right RGB camera 3206 can clearly capture the second image of the conveyance object Cob.

As shown in FIG. 37, a primary computer 3301 and an AI vision processor 3311 correspond to the image-analysing module 2401 and the AI vision processor 2311 described in the second embodiment, respectively, and there is no substantial difference in hardware.

However, software modules of the primary computer 3301 are slightly different from each software module of the primary computer 2301 in the second embodiment.

Further, software modules of the AI vision processor 3311 are also slightly different from each software module of the AI vision processor 2311 in the second embodiment.

As shown in FIG. 37, a conveyer-controlling module 3402, an overriding module 3403, and a training module 3404 are stored in a storage device (not shown in FIGs) of the primary computer 3301 as software modules.

An image-analysing module 3401, which is a software module designed for the AI vision processor 3311, is stored in a storage device (not shown in FIGs) of the AI vision processor 3311.

The conveyer-controlling module 3402 stops the collector conveyor BC₁₀₁ such that the conveyance object Cob is positioned stationary within the second downstream-assessment zone Z_{2d} if the image-analysing module 3401 of the AI vision processor 3311 determines based on the first image that the conveyance state of the conveyance object Cob does not satisfy the forwarding condition.

Further, the conveyer-controlling module 3402 restarts the collector conveyor BC₁₀₁, which is stopped by the conveyer-controlling module 2402, if the image-analysing module 3401 determines based on the second image that the conveyance state of the conveyance object Cob satisfies the forwarding condition.

In the meantime, in the present embodiment, the determination on the conveyance state of the conveyance object Cob in the first upstream-assessment zone Z₁ᵤ is referred to as the ‘primary determination’. On the other hand, the determination on the conveyance state of the conveyance object Cob in the second downstream-assessment zone Z_{2d} is referred to as the ‘secondary determination’.

The overriding module 3403 executes an ‘overriding control’ that forcibly restarts the collector conveyor BC₁₀₁ from the stationary state.

Specifically, this overriding operation is carried out under a situation where the image-analysing module 3401 of the AI vision processor 3311 determined that the conveyance state of the conveyance object Cob was not satisfying the forwarding condition, but an operator completed inputting the overriding command into the touch screen 2305.

The AI vision processor 3311, like the AI vision processor 2311, is a computer dedicated for neural net artificial intelligence (AI) processing.

The AI vision processor 3311 receives the data of the first images captured by the left three-dimensional camera 2203 and the left RGB camera 2204 from the primary computer 3301. Also, the AI vision processor 3311 receives the data of the second images captured by the right three-dimensional camera 3205 and the right RGB camera 3206 from the primary computer 3301.

The image-analysing module 3401 implements the learning model 3405 which has been preliminarily trained for the conveyor supervisor 3000.

The image-analysing module 3401 assesses and determines whether the conveyance state of the conveyance object Cob satisfies the forwarding condition based on the received image data and the trained learning model 3405.

The learning model 3405 defines an assessment standard. Specifically, the learning model 3405 is a machine learning model generated based on a vast amount of raw data (training data), in which a number of conveyance objects are photographed individually, and a learning data set corresponding to the factors of the conveyance objects.

The AI vision processor 3311 transmits results of the assessment and determination process to the primary computer 3301.

A second photo-eye sensor 3211 is provided beside an upstream edge of the second downstream-assessment zone Z_{2d}.

The second photo-eye sensor 3211 is an optical sensor detecting that the conveyance object Cob has entered the second downstream-assessment zone Z_{2d}.

The second photo-eye sensor 3211 is connected to the I/O controller 2304 with a digital I/O cable.

Further, the I/O controller 2304 is communicably connected to the primary computer 3301 via the Ethernet switch 2302.

Hence, the primary computer primary computer 3301 can immediately detect that the conveyance object Cob enters the second downstream-assessment zone Z_{2d} by the second photo-eye sensor 3211.

With the above-mentioned arrangement, the conveyor controlling apparatus according to the third embodiment of the present invention provides the following advantages.

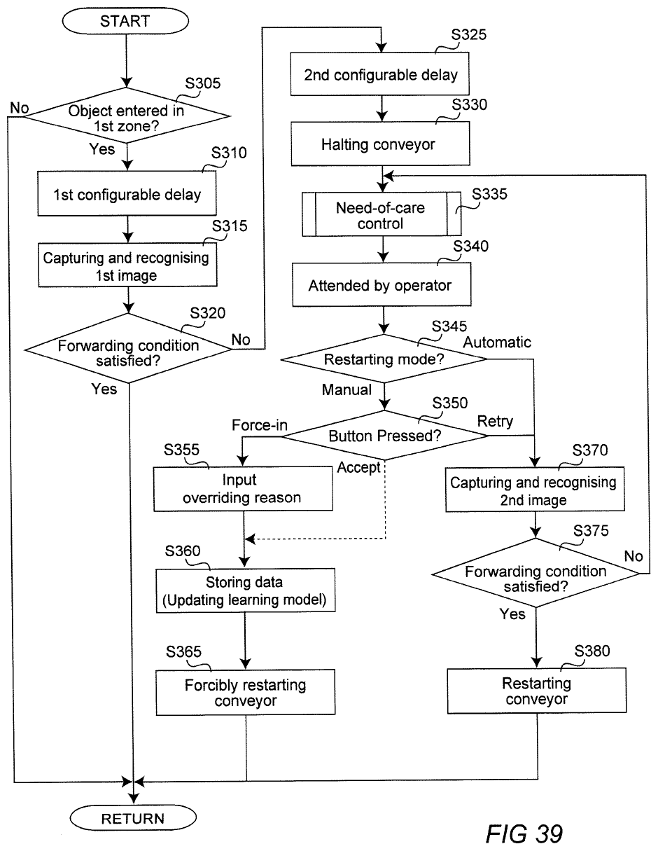

The analysis control of the conveyance object Cob by the conveyor supervisor 3000 is mainly performed in accordance with a main flowchart shown in FIG. 39.

Note that, in parallel with the analysis control of the conveyance object Cob shown in FIG. 411, the intrusion control shown in FIG. 207 is also executed, but the intrusion control which has already been described in the second embodiment, so will be omitted here.

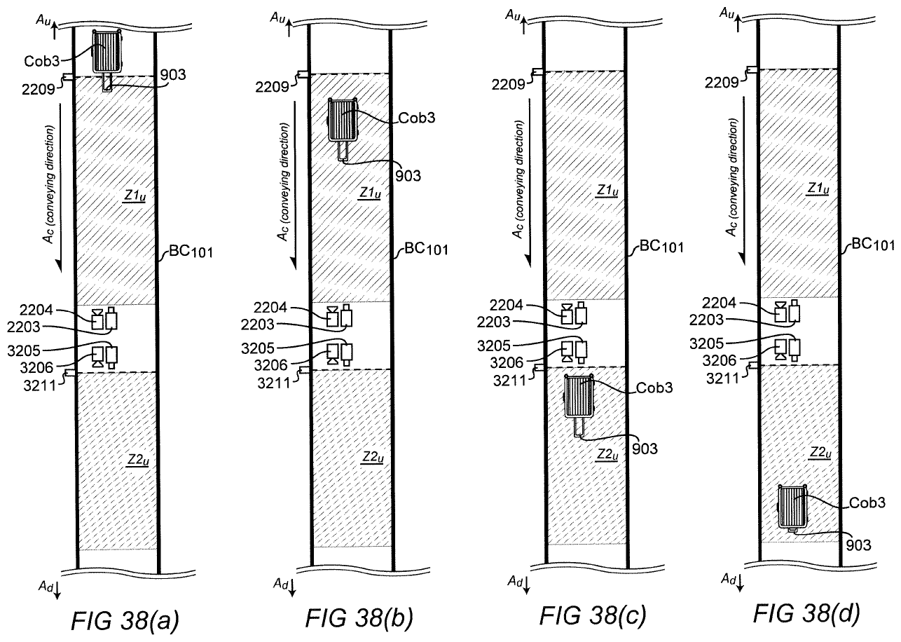

As shown in FIG. 38(a), the conveyer-controlling module 3402 recognises that the conveyance object (suitcase) Cob3 has just entered the first upstream-assessment zone Z₁ᵤ in response to detection by the first photo-eye sensor 2209 that the conveyance object Cob3 which is conveyed from the upstream direction Au to the downstream direction Ad by the collector conveyor BC₁₀₁ (Yes route from step S205 in FIG. 39).

Immediately subsequent to this, the conveyer-controlling module 3402 stays on standby to make a very short delay for ensuring that the entire conveyance object Cob enters the first upstream-assessment zone Z₁ᵤ (step S310).

At this time, the conveyer-controlling module 3402 of the primary computer 3301 obtains the first image of the conveyance object Cob3 captured by each of the left three-dimensional camera 2203 and the left RGB camera 2204 (step 315). During this time, the collector conveyor BC₁₀₁ is still running, hence, the conveyance object Cob3 keeps travelling in the downstream direction Ad.

Then, the image-analysing module 3401 of the AI vision processor 3311 determines whether the conveyance state of the conveyance object Cob3 satisfies the forwarding condition based on the first image captured by each of the left three-dimensional camera 2203 and the left RGB camera 2204 (steps S315 and S320 in FIG. 39).

Also, at this time, the training module 3404 records the analysis results of the conveyance object Cob3 carried out by the image-analysing module 3401 of the AI vision processor 3311 and the captured first image of the conveyance object Cob3 in the external storage server (steps S315 and S320 in FIG. 39).

If the conveyance state of the conveyance object Cob3 satisfies the forwarding condition (Yes route from step S320 in FIG. 39), the conveyer-controlling module 3402 does not perform special control on the automatic baggage handling system Bap. Hence, the collector conveyor BC₁₀₁ continues running and the conveyance object Cob3 is conveyed to the downstream direction Ad.

On the other hand, if the conveyance state of the conveyance object Cob3 does not satisfy the forwarding condition (No route from step S320 in FIG. 39), the conveyer-controlling module 3402 stops the collector conveyor BC₁₀₁ via the conveyor controller of the automatic baggage handling system Bap so that the conveyance object Cob3 is stationary within the second downstream-assessment zone Z_{2d} (step S330 of FIG. 39—see also FIG. 38(c)).

The conveyer-controlling module 3402 recognises that the conveyance object Cob3 has entered the second downstream-assessment zone Z_{2d} in response to the second photo-eye sensor 3211 detecting the conveyance object Cob3.

Nevertheless, the conveyer-controlling module 3402 makes a short delay to ensure that the entire conveyance object Cob3 enters the second downstream-assessment zone Z_{2d} (step S325 in FIG. 39), then stops the collector conveyor BC₁₀₁ (step S330).

After that, at step S335 of FIG. 39, the conveyer-controlling module 3402 executes the ‘need-of-care control’. Note that the need-of-care control has been described in the second embodiment with reference to FIG. 32, so description thereof will be omitted here.

If the operation mode of the conveyor supervisor 3000 with regard to restarting the collector conveyor BC₁₀₁ is ‘automatic’ (Automatic route from step S345), the conveyer-controlling module 3402 obtains the second image of the conveyance object Cob3 captured by each of the right three-dimensional camera 3205 and the right RGB camera 3206 (step S370 in FIG. 39).

Further, the image-analysing module 3401 of the AI vision processor 3311 determines whether the conveyance object Cob3 satisfies the forwarding condition based on the second image captured by the right three-dimensional camera 3205 and the right RGB camera 3206 (steps S370 and S375 in FIG. 39).

Also, at this time, the training module 3404 records the analysis results of the conveyance object Cob3 carried out by the image-analysing module 3401 of the AI vision processor 3311, the determination results as to whether or not the conveyance state of the conveyance object Cob3 satisfies the forwarding condition, and the captured second image of the conveyance object Cob3 in the external storage server (steps S370 and S375 of FIG. 39).

If the conveyance state of the conveyance object Cob3 satisfies the forwarding condition (Yes route from S375), the conveyer-controlling module 3402 restarts the collector conveyor BC₁₀₁ via the conveyor controller of the automatic baggage handling system Bap (step S380). At this time, in the example shown in FIG. 38(d), the handle 903 is now stored in the conveyance object (suitcase) Cob3 and is being conveyed to the downstream direction Ad.

On the other hand, if the operation mode of the conveyor supervisor 3000 with regard to restarting the collector conveyor BC₁₀₁ is ‘manual’ (Manual route from step S345), the conveyer-controlling module 3402 indicates a ‘Force-in’ button and a ‘Retry’ button on the touch screen 2305. FIG. 34 shows an example of the display on the touch screen 2305 at this time.

If the Force-in button is touched by an operator (see Force-in route from step S350 in FIG. 39), the overriding module 3403 indicates on the touch screen 2305 check boxes corresponding to the found problems with respect to the conveyance object Cob3 (see FIG. 12).

In other words, this situation could be, for example, that although an operator has checked the conveyance object Cob3 at step S340, no problem was actually found, and therefore the operator believes that the conveyance object Cob3 should continue travelling in the downstream direction Ad.

At this time, the operator appropriately checks the check boxes corresponding to the reasons why there is no problem with the conveyance object Cob3 (i.e. ‘overriding reason’), then the operator touches a ‘Submit’ button indicated on the touch screen 2305 (step S355).

Also, at this time, the training module 3404 records the analysis results of the conveyance object Cob3 carried out by the image-analysing module 3401 of the AI vision processor 3311, the determination results as to whether or not the conveyance state of the conveyance object Cob3 satisfies the forwarding condition, the captured first image of the conveyance object Cob3, and the overriding reason entered through the touch screen 2305 in the external storage server (step S360).

In addition, the training module 3404 may apply a learning control to the learning model 3405 based on the entered overriding reason.

In short, in the situation where the image-analysing module 3401 of the AI vision processor 3311 has determined that the conveyance state of the conveyance object Cob3 does not satisfy the forwarding condition, but an operator has completed inputting the overriding command through the touch screen 3305, accordingly, the overriding module 3403 executes the overriding control to forcibly restart the collector conveyor BC₁₀₁ via the conveyor controller of the automatic baggage handling system Bap (step S365 of FIG. 39).

In contrast, at the step S350, if an operator touches the Retry button (see Retry route from step S350), the conveyer-controlling module 3402 obtains the second image of the conveyance object Cob3 captured by each of the right three-dimensional camera 3205 and the right RGB camera 3206.

In other words, this situation could be, for example, that although an operator has checked the conveyance object Cob3 in the second downstream-assessment zone Z_{2d} at the step S340, no problem was actually found, and therefore he/she wants to have the conveyor supervisor 3000 reconfirm the conveyance state of the conveyance object Cob, as a precaution.

As another example situation, an operator has solved the problems of the conveyance object Cob3 in the second downstream-assessment zone Z_{2d} at the step S340, and as a precaution, the operator wants to make sure that the correction to the conveyance object Cob3 was appropriate by using the conveyor supervisor 3000.

If the Retry button is touched (see Retry route from step S350), the image-analysing module 3401 of the AI vision processor 3311 determines, based on the second image captured by each of the right three-dimensional camera 3205 and the right RGB camera 3206, whether or not the conveyance state of the conveyance object Cob3 satisfies the forwarding condition (steps S370 and S375).

If the conveyance state of the conveyance object Cob3 satisfies the forwarding condition (Yes route from S375), the conveyer-controlling module 3402 restarts the collector conveyor BC₁₀₁ via the conveyor controller of the automatic baggage handling system Bap (step S380).

Note that an ‘Accept’ button may also be indicated on the touch screen 2305 at the step S350. In this configuration, if the Accept button is touched by an operator, the collector conveyor BC₁₀₁ is forcibly restarted bypassing the step S355 and reaching the step S365. Nevertheless, executing this control shown as the Accept route from the step S350 is normally prohibited because the conveyance object Cob3 is resultantly conveyed in the downstream direction Ad without an operator inputting the overriding command.

Regarding the intrusion control using the CCTV camera 2309 has been described in the second embodiment, so description thereof will be omitted here.

The present invention is not limited to the above-described embodiments and the variants thereof, and can be variously modified and implemented.

In the first to third embodiments, the conveyor supervisors 1000/2000/3000 are installed in the airport AP, but is not limited to this scenario. For example, the conveyor supervisors 1000/2000/3000 may be installed in factories, plants, and/or warehouses.

In the first to third embodiments, the conveyor supervisors 1000/2000/3000 are installed near the collector conveyor BC₁₀₁, partly because, normally, there are more ground-handling staff working in the FOH than the BOH. Accordingly, if the conveyor controlling apparatus Baz is installed in the FOH of the airport AP, then the conveyance object Cob may be quickly attended by the ground-handling staff in the FOH.

Nevertheless, the installation point of the conveyor supervisors 1000/2000/3000 is not limited to this location. For example, the conveyor supervisors 1000/2000/3000 may be installed near the transport conveyor BC₁₀₂ close to the inlet of the BOH in the airport AP.

In the first and third embodiments, as shown in FIG. 1, the conveying direction Ac of the collector conveyor BC₁₀₁ is in the right direction with respect to the conveyor supervisors 1000/3000, but it is not limited to this direction. For example, as shown in FIG. 16, even if the conveying direction Ac of the belt conveyor is the opposite, the conveyor supervisors 1000/3000 may be compatible.

That is, as shown in FIG. 16, when the conveying direction Ac of the collector conveyor BC₁₀₁ is the left-direction with respect to the conveyor supervisors 1000/3000, both of the right three-dimensional camera 205/3205 and the right RGB camera 206/3206 function as the upstream capturing device that captures the upstream image. Likewise, both of the left three-dimensional camera 203/2203 and the left RGB camera 204/2204 function as the downstream capturing device that captures the downstream image.

In this case, the first upstream-assessment zone Z₁ᵤ on the collector conveyor BC₁₀₁ is a virtual area that approximately corresponds to a photographable area of the cameras towards the upstream direction Au (i.e. each of the right three-dimensional cameras 205/3205 and each of the right RGB cameras 206/3206). Likewise, the second downstream-assessment zone Z_{2d} on the collector conveyor BC₁₀₁ is another virtual area that approximately corresponds to a photographable area of the cameras towards the downstream direction Ad (i.e. each of the left three-dimensional cameras 203/2203 and each of the left RGB cameras 204/2204).

The conveyor supervisors 1000/2000/3000 are robust and can work with belt conveyors, roller conveyors, slat conveyors, mesh conveyors and the like. The conveyor supervisors 1000/2000/3000 can also be adapted to work in scenarios where the conveyor has been replaced by robot-type vehicles such as Automated Guided Vehicles (AGVs). Therefore, again, the conveyor supervisors 1000/2000/3000 are not limited for airports. Applicable industries are not limited to the airline sector, and can be applied to various industries.

As a variant of the first to third embodiments, the conveyor supervisors 1000/2000/3000 may recognise a baggage ID printed on a baggage tag which is uniquely affixed to the conveyance object Cob, based on the first image and/or the second image.

In this case, the baggage ID recognised by the conveyor supervisors 1000/2000/3000 may be transmitted to other external systems (e.g. systems under the control of the International Air Transport Association (IATA), other cargo systems, and so on).

Further, the first and/or the second images may be transmitted to other external systems along with the baggage ID recognised by the conveyor supervisors 1000/2000/3000.

Further, the conveyor supervisors 1000/2000/3000 may transmit the first image and/or the second image of the conveyance object Cob, which did not satisfy the forwarding condition, to other external systems.

In the first to third embodiments, the LED illumination of the status indicators 306/2306 is changed in accordance with the working state of the conveyor supervisors 1000/2000/3000, but it is not limited to this configuration. For example, the conveyor supervisors 1000/2000/3000 may include a buzzer (not shown in FIGs) as an alarm device for beeping in accordance with the working state of the conveyor supervisors 1000/2000/3000. According to this configuration, it is possible to notify aurally an operator of the operational state of the conveyor.

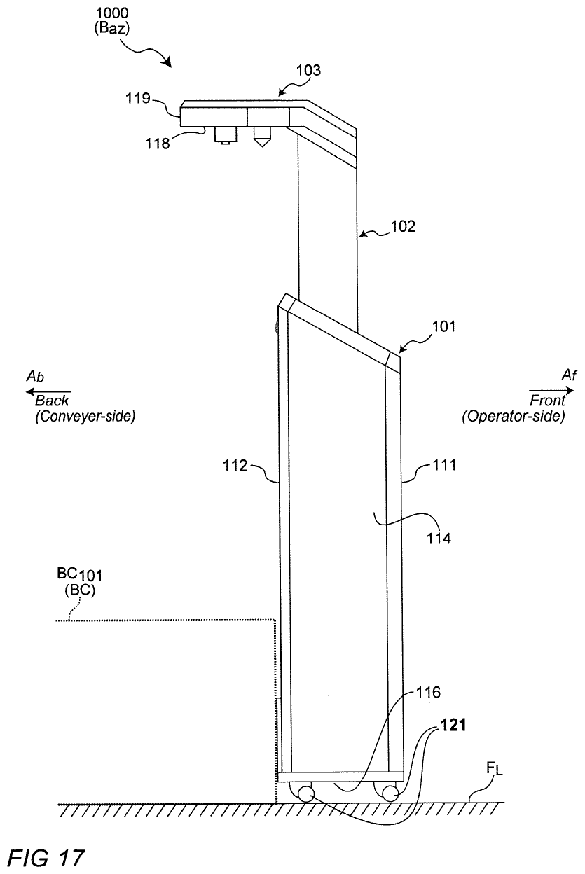

The conveyor supervisors 1000/2000/3000 may be movable. For example, FIG. 17 shows the conveyor supervisor 1000 according to the first embodiment has wheels 121 added to the bottom face 116. According to this arrangement, an operator can easily move the conveyor supervisors 1000/2000/3000 to any desired location.

The primary computers 301/2301/3301 may determine the conveying direction Ac of the collector conveyor BC₁₀₁ based on the first image and/or the second image. That is, the conveyor supervisors 1000/2000/3000 may judge the conveying direction Ac of the collector conveyor BC₁₀₁ is either rightwards (see FIG. 1) or leftwards (see FIG. 16) based on the first image and/or the second image.

In the first and third embodiments, respective first photo-eye sensors 209/2209 are provided beside the first upstream-assessment zone Z₁ᵤ, and respective second photo-eye sensors 211/3211 are provided beside the second downstream-assessment zone Z₂ᵤ. Further, in the second embodiment, the first photo-eye sensor 2209 is provided is beside the first upstream-assessment zone Z₁ᵤ, and the second photo-eye sensor 2211 is provided is beside the second upstream-assessment zone Z₂ᵤ.

However, it is not limited to theses configurations.

For example, without using the first photo-eye sensors 209/2209, the primary computers 301/2301/3301 according to the first to third can detect an entry of a conveyance object Cob into the first upstream-assessment zone Z₁ᵤ based on the first image.

Similarly, even without using the second photo-eye sensors 211/3211, the primary computers 301/3301 according to the first and third embodiments can detect an entry of a conveyance object Cob into the second upstream-assessment zone Z₂ᵤ based on the downstream image.

Likewise, without using the second photo-eye sensor 2211, the primary computer 2301 according to the second embodiment can detect an entry of a conveyance object Cob into the second downstream-assessment zone Z_{2d} based on the second image.

Nevertheless, by using the first and second photo-eye sensors 209, 221, 2209, 2211 and 3211, the processing load of the conveyor supervisors 1000/2000/3000 may be reduced.

In the first to third embodiments, the height of a conveyance object is detected based on the captured image by the three-dimensional camera. However, it is not limited to this configuration.

For example, an optical height sensor may be provided beside the conveyor.

According to this configuration, it is possible to judge more directly whether or not the height of the conveyance object Cob is beyond the predetermined height limit.

In the second embodiment, the image-analysing module 2401 of the AI vision processor 2311 analyses and determines whether the conveyance state of the conveyance object Cob satisfies the forwarding condition.

Likewise, in the third embodiment, the image-analysing module 3401 of the AI vision processor 3311 analyses and determines whether the conveyance state of the conveyance object Cob satisfies the forwarding condition.

However, it is not limited to these configurations.

For example, the technology described in the second embodiment may be realised by a single computer that integrates all the features of the primary computer 2301 and the AI vision processor 2311.

Also, the technology described in the third embodiment may be realised by a single computer that integrates all the features of the primary computer 3301 and the AI vision processor 3311.

In the first to third embodiments, the secondary computers 308/2308 carry out the intrusion control using the CCTV camera 212/2309. However, it is not limited to these configurations.

For example, the technology described in the first to third embodiments may be realised by a single computer that integrates all the features of the primary computers 301/2301/3301 and the secondary computers 308/2308.

In the first to third embodiments, the case where the conveyor supervisors 1000/2000/3000 are applied to the straight collector conveyor BC₁₀₁ has been described, but it is not limited to this. For example, the conveyor supervisors 1000/2000/3000 are applicable to curbed conveyors.

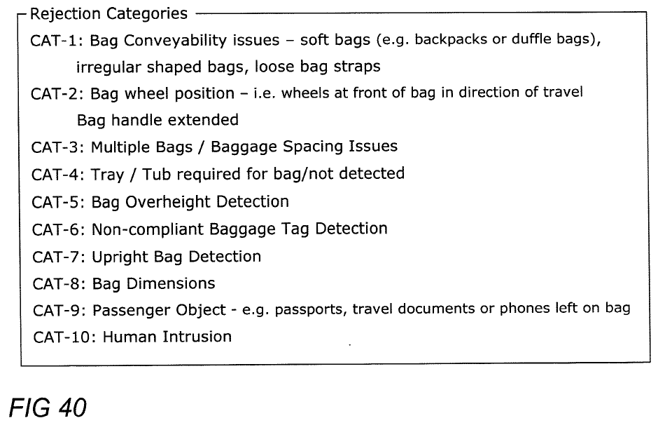

The situations in which a conveyance state of a conveyance object Cob does not satisfy the forwarding conditions as discussed in the first to third embodiments may corresponds to at least one of ‘rejection categories’ shown in FIG. 40.

In the first to third embodiments, the data related to analysis/determination of the conveyance object Cob3, the data related to the intrusion control, and the data related to the captured images of the conveyance object Cob3 is recorded to the external storage server, but it is not limited to this configuration.

For example, it is also possible to employ a configuration in which the data relating to the analysis/determination of the conveyance object Cob, the intrusion control, and the data related to the captured images of the conveyance object Cob is recorded to an internal storage device (now shown in FIGs) provided in the conveyor supervisor 1000/2000/3000.

As described in detail above, according to the control device and control method of the present invention, the conveyor is controlled according to the environmental parameters of the conveyor, so that the reliability of the conveyance system having the conveyor can be improved.

In addition, by stopping the conveyor according to different forwarding conditions depending on the conveyance system having the conveyor and the image of the conveyance objects, it is possible to improve the accuracy of flow control for the conveyance objects. Further, it is possible to improve overall operational efficiencies of the conveyance system.

Further, when it is later determined that the conveyance state of the conveyance object now satisfies the forwarding condition of the conveyor, the conveyer can be quickly restarted.

Also, the conveyance state of the conveyance object may be determined in the first assessment zone, and the conveyor may be stopped so that the conveyance object is positioned within the second assessment zone according to the determination result. Further, the conveyance object within the second basement zone may be further determined, and the conveyor may be restarted depending on the determination result.

Note that the first assessment zone may be defined on the upstream side of the capturing device, and the second assessment zone may be defined on the downstream side of the capturing device.

Also, the learning model may be used in determining the image of the conveyance object.

Moreover, even if it is determined that the conveyance state of the conveyance object does not satisfy the forwarding condition, the control for forcibly restarting the conveyor, that is, the overriding control may be executed. However, when executing this overriding control, the reason for the execution must be included, so that more accurate control of the conveyance object can be realised.

Further, it improves the operational reliability of the transport system having the conveyor by immediately stopping the conveyor if any human is detected with in the keep-out zone.

Also, the conveyor can be restarted quickly if no humans are detected within the keep-out zone.

In addition, by making the conveyor controlling apparatus compact with the main body, the apparatus can be adapted to various types of conveyors.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

The reference to any prior art in this specification is not, and should not be taken as, an acknowledgement or any form of suggestion that the prior art forms part of the common general knowledge.

### REFERENCE SIGNS LIST

101 main body
102 pillar
103 sensor head (head unit)
203 left three-dimensional camera (upstream capturing device/first capturing device/capturing device)
204 left RGB camera (upstream capturing device/first capturing device/capturing device)
205 right three-dimensional camera (downstream capturing device/second capturing device/capturing device)
206 right RGB camera (downstream capturing device/second capturing device/capturing device)
207 left light (upstream lighting device)
208 right light (downstream lighting device)
212 CCTV camera (intrusion camera/capturing device)
301 primary AI computer (image-analysing module, training module)
303 system computer (overriding module)
304 I/O controller (conveyor-controlling module)
306 status indicator (alarm device)
307 learning model
1000 conveyor supervisor (conveyor controlling apparatus)
2000/3000 conveyor supervisor (conveyor controlling apparatus)
2101 main body
2102 pillar
2103 sensor head (head unit)
2203 left three-dimensional camera (first image-capturing device/capturing device)
2204 left RGB camera (first image-capturing device/capturing device)
2309 CCTV camera (intrusion camera/capturing device)
2401/3401 image-analysing module
2402/3402 conveyer-controlling module
2403/3403 overriding module
2404/3404 training module
2405/3405 learning model
2407 intrusion-analysing module
3205 right three-dimensional camera (second image-capturing device/capturing device)
3206 right RGB camera (second image-capturing device/capturing device)
Ad downstream direction
Au upstream direction
Baz conveyor controlling apparatus
BC conveyer
BC₁₀₁ collector conveyor (conveyor)
BC₁₀₁₋₁ first collector conveyor (conveyor)
BC₁₀₁₋₂ second collector conveyor (conveyor)
Cob conveyance object
Dz zone-separation distance
H_{inf} infant (human)
Za assessment zone
Z_{K} keep-out zone
Z₁ᵤ first upstream-assessment zone (first assessment zone/upstream assessment zone/assessment zone)
Z_{2d} second downstream-assessment zone (second assessment zone/downstream assessment zone/assessment zone)
Z_{2d} second upstream-assessment zone (second assessment zone/upstream assessment zone/assessment zone)

1. A conveyor controlling apparatus for controlling a conveyor in accordance with environment parameters with respect to the conveyor, the apparatus comprising:
a capturing device for capturing an environmental image related to the conveyor;
an image-analysing module for determining, based on the environmental image captured by the capturing device, whether an operational condition of the conveyor is satisfied; and
a conveyor-controlling module for controlling the conveyor based on a result of the determination carried out by the image-analysing module,
wherein if the image-analysing module determines that the operational condition is not satisfied, then the conveyor-controlling module stops the conveyor.

2. The conveyor controlling apparatus according claim 1, wherein
the capturing device captures an object image of a conveyance object on the conveyor when the conveyance object is in an assessment zone on the conveyor,
the object image is the environmental image with respect to the conveyance object,
the image-analysing module determines based on the object image captured by the capturing device whether a conveyance state of the conveyance object satisfies a forwarding condition,
the forwarding condition is the operational condition with respect to the conveyance object, and
if the image-analysing module determines based on the object image that the conveyance state of the conveyance object does not satisfy the forwarding condition, then the conveyor-controlling module stops the conveyor such that the conveyance object is positioned within the assessment zone.

3. The conveyor controlling apparatus according to claim 2, wherein
when the conveyor is stopped by the conveyor-controlling module, if the image-analysing module determines based on the object image of the conveyance object stopped in the assessment zone that the conveyance state of the conveyance object satisfies the forwarding condition, then the conveyor-controlling module restarts the conveyor.

4. The conveyor controlling apparatus according to claim 2, wherein
the assessment zone includes
a first assessment zone, and
a second assessment zone which is provided in a downstream direction with respect to the first assessment zone,
the first assessment zone is an area in which the object image is captured as a first image by the capturing device while the conveyance object is conveyed by the conveyor,
the second assessment zone is an area in which the object image is captured as a second image by the capturing device while the conveyance object is stationary on the conveyor when the conveyor is stopped by the conveyor-controlling module,
the conveyor-controlling module stops the conveyor such that the conveyance object is positioned within the second assessment zone if the image-analysing module determines based on the first image that the conveyance state of the conveyance object does not satisfy the forwarding condition, and
when the conveyor is stopped by the conveyor-controlling module, if the image-analysing module determines based on the second image that the conveyance state of the conveyance object satisfies the forwarding condition, then the conveyor-controlling module restarts the conveyor.

5. The conveyor controlling apparatus according to claim 4, wherein
the capturing device includes
a first image-capturing device for capturing the first image, and
a second image-capturing device for capturing the second image,
the first assessment zone is defined on the conveyor provided in an upstream direction with respect to the first image-capturing device, and
the second assessment zone is defined on the conveyor provided in the downstream direction with respect to the second image-capturing device.

6. The conveyor controlling apparatus according to claim 2, wherein
the image-analysing module is further configured to implement a learning model,
the learning model defines an assessment standard for the conveyance state, and
the image-analysing module utilises the learning model in the determination of whether the conveyance state of the conveyance object satisfies the forwarding condition.

7. The conveyor controlling apparatus according to claim 2, further comprising:
an overriding module for executing an overriding operation, which is an operation to forcibly restart the conveyor, even when the image-analysing module determines based on the object image that the conveyance state of the conveyance object does not satisfy the forwarding condition, in response to an overriding command; and
a training module for updating the learning model based on the overriding command and the object image of the conveyance object when the overriding operation is executed by the overriding module, wherein
the overriding command must include an overriding reason for execution of the overriding operation.

8. The conveyor controlling apparatus according to claim 1, further comprising:
an intrusion camera as the capturing device for capturing an intrusion image; and
an intrusion-analysing module for determining based on the intrusion image captured by the intrusion camera whether an intrusion state of the keep-out zone satisfies an intrusion condition, wherein
the intrusion image is the environmental image with respect to a keep-out zone which is an area including at least the conveyer,
the intrusion condition, which is the operational condition with respect to the keep-out zone, is a condition that any human is not detected in the keep-out zone,
if the intrusion-analysing module determines that the intrusion state does not satisfy the intrusion condition, then the conveyor-controlling module stops the conveyor.

9. The conveyor controlling apparatus according to claim 8, wherein
when the conveyor is stopped by the conveyor-controlling module because of the determination by the intrusion-analysing module that the intrusion condition was not satisfied, if the intrusion-analysing module determines based on the intrusion image that the intrusion state satisfies the intrusion condition, then the conveyor-controlling module restarts the conveyor.

10. The conveyor controlling apparatus according to claim 1, further comprising:
a main body in which has the image-analysing module and the conveyor-controlling module;
a pillar extending upwardly from the main body; and
a head unit, which is provided at a top end of the pillar, housing the capturing device.

11. A conveyor controlling method for controlling a conveyor in accordance with environment parameters with respect to the conveyor, the method comprising:
providing a capturing device;
first capturing an environmental image related to the conveyor by the capturing device;
first determining, based on the environmental image captured in the first capturing, whether an operational condition of the conveyor is satisfied; and
conveyor-controlling the conveyor based on a result of the determination carried out by the first determining,
wherein if the first determining determines based on the environmental image that the operational condition is not satisfied, then the conveyor-controlling stops the conveyor.

12. The method according to claim 11, wherein
the first capturing captures an object image of a conveyance object on the conveyor when the conveyance object is in an assessment zone on the conveyor,
the object image is the environmental image with respect to the conveyance object,
the first determining determines, based on the object image captured in the first capturing, whether a conveyance state of the conveyance object satisfies a forwarding condition,
the forwarding condition is the operational condition with respect to the conveyance object, and
if the first determining determines based on the object image that the conveyance state of the conveyance object does not satisfy the forwarding condition, then the conveyor-controlling stops the conveyor such that the conveyance object is positioned within the assessment zone.

13. The method according to claim 12, further comprising:
second capturing the object image of the conveyance object in the assessment zone by the capturing device when the conveyor is stopped by the stopping;
second determining based on the object image of the conveyance object stopped in the assessment zone captured by the second capturing whether the conveyance state of the conveyance object satisfies the forwarding condition; and
restarting the conveyer if the second determining determines that the conveyance state satisfies the forwarding condition.

14. The method according to claim 13, wherein
the first capturing captures the object image as a first image when the conveyance object is within a first assessment zone which is a part of the assessment zone,
the second capturing captures the object image as a second image when the conveyance object is within a second assessment zone which is another part of the assessment zone and is provided in a downstream direction with respect to the first-assessment zone,
the first determining is carried out by determining, based on the first image captured in the first capturing, whether the conveyance state of the conveyance object in the first assessment zone satisfies the forwarding condition,
the second determining is carried out by determining, based on the second image captured in the second capturing, whether the conveyance state of the conveyance object in the second assessment zone satisfies the forwarding condition,
the conveyor-controlling stops the conveyor such that the conveyance object is positioned within the second assessment zone if the first determining determines that the conveyance state of the conveyance object in the first assessment zone does not satisfy the forwarding condition, and
the restarting restarts the conveyer if the second determining determines based on the second image, when the conveyor is stopped by the stopping, that the conveyance state of the conveyance object in the second assessment zone satisfies the forwarding condition.

15. The method according to claim 14, further comprising:
providing a first image-capturing device, as a part of the capturing device, for capturing the first image, and
providing a second image-capturing device, as another part of the capturing device, for capturing the second image, wherein
the first assessment zone is defined on the conveyor provided in an upstream direction with respect to the first image-capturing device, and
the second assessment zone is defined on the conveyor provided in the downstream direction with respect to the second image-capturing device.

16. The method according to claim 12, further comprising:
providing a learning model, which defines an assessment standard for the conveyance state, being utilised in the determination of whether the conveyance state of the conveyance object satisfies the forwarding condition.

17. The method according to claim 16, further comprising:
executing an overriding operation, which is an operation forcibly restarts the conveyor, even when the second determining determines that the conveyance state of the conveyance object in the second assessment zone does not satisfy the forwarding condition, in response to an overriding command; and
updating the learning model based on the overriding command and the object image when the overriding operation is executed by the executing, wherein
the overriding command must include an overriding reason for execution of the overriding operation.

18. The method according to claim 11, further comprising:
preparing an intrusion camera as the capturing device for capturing an intrusion image;
intrusion-determining, based on the intrusion image captured by the intrusion camera, whether an intrusion state of the keep-out zone satisfies an intrusion condition; wherein
the intrusion image is the environmental image with respect to a keep-out zone which is an area including at least the conveyer,
the intrusion condition, which is the operational condition with respect to the keep-out zone, is a condition that any human is not detected in the keep-out zone, and
if the intrusion-determining determines that the intrusion state does not satisfy the intrusion condition, then the conveyor-controlling stops the conveyor.

19. The method according to claim 18, wherein
when the conveyor is stopped by the conveyor-controlling because of the determination by the intrusion-determining that the intrusion condition was not satisfied, if the intrusion-determining determines based on the object image that the intrusion state satisfies the intrusion condition, then the conveyor-controlling restarts the conveyor.

20. The method according to any one of claim 11, further comprising:
providing a main body;
providing a pillar extending upwardly from the main body; and
providing a head unit, which houses the capturing device, at a top end of the pillar.
